(19) United States
(12) Patent Application Publication
(10) Pub. No.: US 2014/0063160 A1
(43) Pub. Date: Mar. 6, 2014

(54) IMAGE FORMING APPARATUS AND IMAGE FORMING METHOD

(71) Applicant: FUJIFILM CORPORATION, Tokyo (JP)

(72) Inventor: Hiroaki HOUJOU, Kanagawa (JP)

(73) Assignee: FUJIFILM CORPORATION, Tokyo (JP)

(21) Appl. No.: 14/010,563

(22) Filed: Aug. 27, 2013

(30) Foreign Application Priority Data
Aug. 29, 2012 (JP) 2012-189165

(51) Int. Cl. B41J 11/00

(52) U.S. Cl. CPC B41J 11/0015
USPC 347/102

(57) ABSTRACT

An image forming apparatus including: a jetting head that jets, onto a recording medium, a curable ink composition including 3% by mass to 18% by mass, based on a total amount of the ink composition, of a polyfunctional polymerizable compound, and water; a chain gripper that grips a leading end of the recording medium onto which the curable ink composition has been jetted from the jetting head, and conveys the recording medium; and an irradiation device that irradiates light to the recording medium which is conveyed by the chain gripper and onto which the curable ink composition has been jetted.

### CROSS-REFERENCE TO RELATED APPLICATION

This application claims priority under 35 USC 119 from Japanese Patent Application No. 2012-189165 filed on Aug. 29, 2012, the disclosure of which is incorporated by reference herein.

### BACKGROUND OF THE INVENTION

1. Field of the Invention

The invention relates to an image forming apparatus and an image forming method.

2. Description of the Related Art

Japanese Patent Application Laid-Open (JP-A) No. 2010-76872 discloses an image forming apparatus having a chain gripper which grips a leading end of a paper sheet on which an image has been recorded with an aqueous UV ink and conveys the sheet to a paper discharge section, and irradiating UV light to the aqueous UV ink on the paper sheet during the conveyance by this chain gripper.

When duplex printing is performed using an image forming apparatus disclosed in JP-A No. 2010-76872, however, the image on the paper sheet is rubbed with a conveyance surface during conveyance by the chain gripper, and thus the image may be damaged or the conveyance surface may be stained with the ink. In addition, the paper sheet may be deformed when an ink is cured by UV irradiation.

### SUMMARY OF THE INVENTION

According to an aspect of the invention, there is provided an image forming apparatus comprising:

a jetting head that jets, onto a recording medium, a curable ink composition including 3% by mass to 18% by mass, based on a total amount of the ink composition, of a polyfunctional polymerizable compound, and water;

a chain gripper that grips a leading end of the recording medium onto which the curable ink composition has been jetted from the jetting head, and conveys the recording medium; and

an irradiation device that irradiates light to the recording medium which is conveyed by the chain gripper and onto which the curable ink composition has been jetted.

### BRIEF DESCRIPTION OF THE DRAWINGS

Exemplary embodiments of the present invention will be described in detail based on the following FIGURE, wherein:

FIG. 1 is a schematic side view of an inkjet recording apparatus as one example of an image forming apparatus according to an embodiment of the invention, in which the overall configuration of the apparatus is cut along a vertical plane.

### DETAILED DESCRIPTION OF THE INVENTION

Image forming apparatuses according to embodiments of the invention will be specifically explained below, referring to attached drawing. In the drawing, the same signs are applied to members (structural components) having the same or corresponding functions, and the explanations thereof will be arbitrarily omitted.

—Overall Configuration—

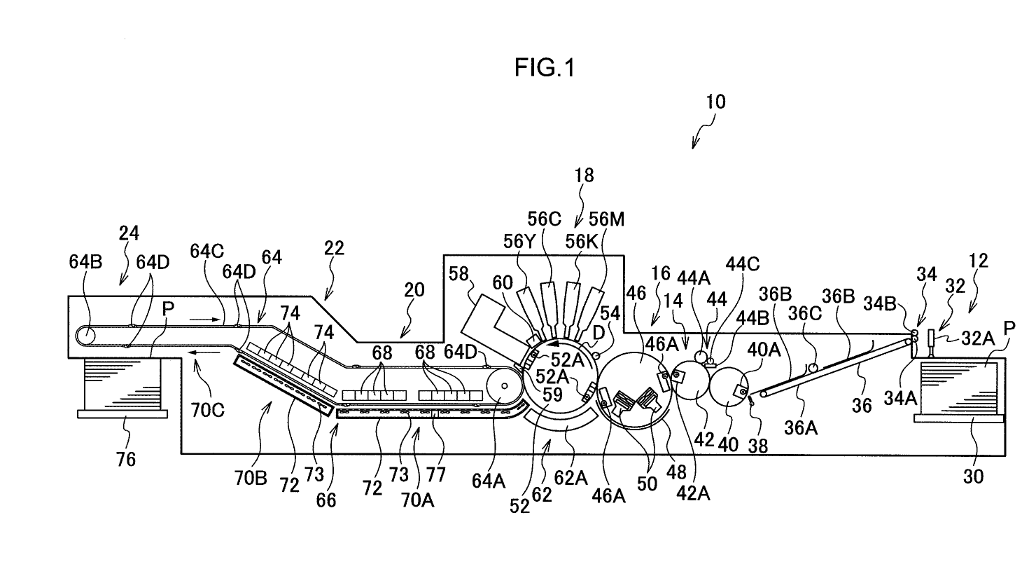

As shown in FIG. 1, the inkjet recording apparatus 10 is an inkjet recording apparatus that uses aqueous UV inks (ultraviolet (UV)-curable inks using an aqueous medium) to record an image by the inkjet method on paper sheets (recording medium) P. The inkjet recording apparatus 10 is mainly equipped with a paper feed section 12 that feeds the paper sheets P, a process liquid application section 14 that applies a predetermined process liquid to front surfaces (image recording surfaces) of the paper sheets P that have been fed from the paper feed section 12, a process liquid drying treatment section 16 that administers a drying treatment to the paper sheets P to which the process liquid has been applied by the process liquid application section 14, an image recording section 18 that uses aqueous UV inks to record an image by the inkjet method on the front surfaces of the paper sheets P to which the drying treatment has been administered by the process liquid drying treatment section 16, an ink drying treatment section 20 that administers a drying treatment to the paper sheets P on which the images have been recorded by the image recording section 18, a UV irradiation treatment section 22 that administers a UV irradiation treatment (fixing treatment) to the paper sheets P to thereby fix the images, and a paper discharge section 24 that discharges the paper sheets P to which the UV irradiation treatment has been administered by the UV irradiation treatment section 22.

<Paper Feed Section>

The paper feed section 12 feeds the paper sheets P, which are stacked in a paper feed tray 30, one sheet at a time to the process liquid application section 14. The paper feed section 12 that serves as an example of a paper feed section is mainly configured by the paper feed tray 30, a sucker device 32, a paper feed roller pair 34, a feeder board 36, a feed guide 38, and a paper feed drum 40.

The paper sheets P are placed in the paper feed tray 30 as a stack in which numerous sheets are stacked on top of each other. The paper feed tray 30 is disposed in such a way that it can be raised and lowered by an unillustrated paper feed tray raising-and-lowering device. The driving of the paper feed tray raising-and-lowering device is controlled in conjunction with increases and decreases in the number of the paper sheets P stacked in the paper feed tray 30. The paper feed tray raising-and-lowering device raises and lowers the paper feed tray 30 in such a way that the paper sheet P positioned in the uppermost position of the stack is always positioned at a fixed height.

The paper sheets P that serve as the recording medium are not particularly limited, and general-purpose printing paper (paper mainly consisting of cellulose, such as so-called wood-free paper, coated paper, and art paper) used in common offset printing and so forth can be used.

The sucker device 32 picks up, one sheet at a time sequentially from above, the paper sheets P stacked in the paper feed tray 30 and feeds the paper sheets P to the paper feed roller pair 34. The sucker device 32 is equipped with a suction foot 32A that is disposed in such a way that it may be freely raised and lowered and freely swung. The sucker device 32 sucks and holds the upper surface of the paper sheet P with the suction foot 32A and transfers the paper sheet P from the paper feed tray 30 to the paper feed roller pair 34. At this time, the suction foot 32A sucks and holds the upper surface on the leading end side of the paper sheet P positioned in the uppermost position of the stack, pulls up the paper sheet P, and inserts the leading end of the paper sheet P between a pair of rollers 34A and 34B configuring the paper feed roller pair 34.

The paper feed roller pair 34 is configured by an upper and lower pair of rollers 34A and 34B that are pressed against and brought into contact with each other. One of the upper and lower pair of rollers 34A and 34B is configured to serve as a drive roller (the roller 34A) and the other is configured to serve as a driven roller (the roller 34B). The drive roller (the roller 34A) is driven to rotate by an unillustrated motor. The motor is driven in conjunction with the feeding of the paper sheet P, and when the paper sheet P is fed from the sucker device 32, the motor causes the drive roller (the roller 34A) to rotate in accordance with the timing of the feeding. The paper sheet P that has been inserted between the upper and lower pair of rollers 34A and 34B is nipped by the rollers 34A and 34B and is fed in the direction of rotation of the rollers 34A and 34B (the installation direction of the feeder board 36).

The feeder board 36 is formed in correspondence to the width of the paper sheets P, receives the paper sheet P that has been fed from the paper feed roller pair 34, and guides the paper sheet P to the feed guide 38. The feeder board 36 is installed in such a way as to incline downward, allows the paper sheet P that has been placed on top of its conveyance surface to slide along the conveyance surface, and guides the paper sheet P to the feed guide 38.

Tape feeders 36A for conveying the paper sheet P are plurally installed, at intervals apart from each other in the width direction, on the feeder board 36. The tape feeders 36A are formed in endless shapes and are driven to rotate by an unillustrated motor. The paper sheet P that has been placed on the conveyance surface of the feeder board 36 is fed by the tape feeders 36A and is conveyed on top of the feeder board 36.

Further, retainers 36B and a roller 36C are installed on top of the feeder board 36. The retainers 36B are plurally placed in a longitudinal row upstream and downstream along a conveyance surface of the paper sheet P (in the present example, there are two retainers 36B). The retainers 36B are configured by plate springs that have a width corresponding to the width of the paper sheets P. The retainers 36B are installed in such a way that they are pressed against and brought into contact with the conveyance surface. The paper sheet P conveyed on top of the feeder board 36 by the tape feeders 36A passes through the retainers 36B, whereby unevenness is corrected.

The roller 36C is disposed between the upstream and downstream retainers 36B. The roller 36C is installed in such a way that it is pressed against and brought into contact with the conveyance surface of the paper sheet P. The paper sheet P conveyed between the upstream and downstream retainers 36B is conveyed while its upper surface is held down by the roller 36C.

The feed guide 38 corrects the posture of the paper sheet P. The feed guide 38 is formed in a plate shape and is placed orthogonal to the conveyance direction of the paper sheet P. Further, the feed guide 38 is driven by an unillustrated motor and is disposed in such a way that it can swing. The leading end of the paper sheet P that has been conveyed on top of the feeder board 36 is brought into contact with the feed guide 38, whereby the posture of the paper sheet P is corrected (so-called skew prevention). The feed guide 38 swings in conjunction with the feeding of the paper sheet P to the paper feed drum 40 and transfers the paper sheet P whose posture has been corrected to the paper feed drum 40.

The paper feed drum 40 receives the paper sheet P fed from the feeder board 36 via the feed guide 38 and conveys the paper sheet P to the process liquid application section 14. The paper feed drum 40 is formed in a cylindrical shape and is driven to rotate by an unillustrated motor. A gripper 40A is disposed on the outer peripheral surface of the paper feed drum 40, and the leading end of the paper sheet P is gripped by the gripper 40A. The paper feed drum 40 grips the leading end of the paper sheet P with the gripper 40A and rotates, whereby the paper feed drum 40 wraps the paper sheet P onto its peripheral surface and conveys the paper sheet P to the process liquid application section 14.

<Process Liquid Application Section>

The process liquid application section 14 applies a predetermined process liquid to the front surface (image recording surface) of the paper sheet P. The process liquid application section 14 is mainly configured by a process liquid application drum 42 that conveys the paper sheet P and a process liquid application unit 44 that applies the predetermined process liquid to a printing surface of the paper sheet P conveyed by the process liquid application drum 42. The process liquid applied to the front surface of the paper sheet P is an aggregating agent that has the function of causing color materials (pigments) in the aqueous UV inks jetted onto the paper sheet P by the downstream image recording section 18 to aggregate. By applying the process liquid to the front surface of the paper sheet P and jetting the aqueous UV ink, high-definition printing can be performed without causing landing interference or the like even in the case of using general-purpose printing paper.

The process liquid application drum 42 receives the paper sheet P from the paper feed drum 40 of the paper feed section 12 and conveys the paper sheet P to the process liquid drying treatment section 16. The process liquid application drum 42 is formed in a cylindrical shape and is driven to rotate by an unillustrated motor. A gripper 42A is disposed on the outer peripheral surface of the process liquid application drum 42, and the leading end of the paper sheet P is gripped by the gripper 42A. The process liquid application drum 42 grips the leading end of the paper sheet P with the gripper 42A and rotates, whereby the process liquid application drum 42 wraps the paper sheet P onto its peripheral surface and conveys the paper sheet P to the process liquid drying treatment section 16 (the process liquid application drum 42 conveys one paper sheet P by one rotation). The rotation of the process liquid application drum 42 and the rotation of the paper feed drum 40 are controlled in such a way that the timing of the receipt of the paper sheet P by the process liquid application drum 42 and the timing of the transfer of the paper sheet P by the paper feed drum 40 coincide. That is, the process liquid application drum 42 and the paper feed drum 40 are driven in such a way that they have the same circumferential speed and are driven in such a way that the positions of their respective grippers coincide.

The process liquid application unit 44 applies the process liquid by means of a roller to the front surface of the paper sheet P conveyed by the process liquid application drum 42. The process liquid application unit 44 is mainly configured by an application roller 44A that applies the process liquid to the paper sheet P, a process liquid tank 44B in which the process liquid is stored, and a draw roller 44C that draws up the process liquid stored in the process liquid tank 44B and supplies the process liquid to the application roller 44A.

<Process Liquid Drying Treatment Section>

The process liquid drying treatment section 16 administers a drying treatment to the paper sheet P to whose front surface the process liquid has been applied. The process liquid drying treatment section 16 is mainly configured by a process liquid drying treatment drum 46 that conveys the paper sheet P, a paper sheet conveyance guide 48, and a process liquid drying treatment unit 50 that blows dry air onto the printing surface of the paper sheet P conveyed by the process liquid drying treatment drum 46 to thereby dry the printing surface of the paper sheet P.

The process liquid drying treatment drum 46 receives the paper sheet P from the process liquid application drum 42 of the process liquid application section 14 and conveys the paper sheet P to the image recording section 18. The process liquid drying treatment drum 46 is configured by a frame body assembled in a cylindrical shape and is driven to rotate by an unillustrated motor. A gripper 46A is disposed on the outer peripheral surface of the process liquid drying treatment drum 46, and the leading end of the paper sheet P is gripped by the gripper 46A. The process liquid drying treatment drum 46 grips the leading end of the paper sheet P with the gripper 46A and rotates, whereby the process liquid drying treatment drum 46 conveys the paper sheet P to the image recording section 18. The process liquid drying treatment drum 46 of the present example is configured in such a way that the gripper 46A is disposed in two places on the outer peripheral surface of the process liquid drying treatment drum 46 so that two of the paper sheets P can be conveyed by one rotation. The rotation of the process liquid drying treatment drum 46 and the rotation of the process liquid application drum 42 are controlled in such a way that the timing of the receipt of the paper sheet P by the process liquid drying treatment drum 46 and the timing of the transfer of the paper sheet P by the process liquid application drum 42 coincide. That is, the process liquid drying treatment drum 46 and the process liquid application drum 42 are driven in such a way that they have the same circumferential speed and are driven in such a way that the positions of their respective grippers coincide.

The paper sheet conveyance guide 48 is disposed along the conveyance path of the paper sheet P resulting from the process liquid drying treatment drum 46 and guides the conveyance of the paper sheet P.

The process liquid drying treatment unit 50 is installed on the inside of the process liquid drying treatment drum 46 and blows dry air toward the front surface of the paper sheet P conveyed by the process liquid drying treatment drum 46 to thereby administer a drying treatment to the paper sheet P. Because of this, the solvent component in the process liquid is removed and an ink aggregation layer is formed on the front surface of the paper sheet P. In the present example, two of the process liquid drying treatment units 50 are disposed inside the process liquid drying treatment drum 46 and are given a configuration that blows dry air toward the front surface of the paper sheet P conveyed by the process liquid drying treatment drum 46.

<Image Recording Section>

The image recording section 18 jets liquid droplets of aqueous ultraviolet-curable color inks (aqueous UV inks) of the colors of M, K, C, and Y onto the printing surface of the paper sheet P to thereby form a color image on the printing surface of the paper sheet P. The image recording section 18 is mainly configured by an image recording drum 52 that conveys the paper sheet P, a paper sheet holding roller 54 that presses the paper sheet P conveyed by the image recording drum 52 to thereby bring the paper sheet P into close contact with the peripheral surface of the image recording drum 52, inkjet heads 56M, 56K, 56C, and 56Y that serve as an example of jetting heads that jet ink droplets of the colors of M, K, C, and Y onto the paper sheet P, an inline sensor 58 that reads the image that has been recorded on the paper sheet P, a mist filter 60 that traps ink mist, and a drum cooling unit 62. As mentioned above, aqueous UV inks are used for the inks jetted from the inkjet heads 56M, 56K, 56C, and 56Y. The aqueous UV inks can be cured by irradiating them with ultraviolet (UV) light after the aqueous UV inks have been jetted. The compositions of the aqueous UV inks will be described later.

The image recording drum 52 receives the paper sheet P from the process liquid drying treatment drum 46 of the process liquid drying treatment section 16 and conveys the paper sheet P to the ink drying treatment section 20. The image recording drum 52 is formed in a cylindrical shape and is driven to rotate by an unillustrated motor. A gripper 52A is disposed on the outer peripheral surface of the image recording drum 52, and the leading end of the paper sheet P is gripped by the gripper 52A. The image recording drum 52 grips the leading end of the paper sheet P with the gripper 52A and rotates, whereby the image recording drum 52 wraps the paper sheet P onto its peripheral surface and conveys the paper sheet P to the ink drying treatment section 20. Further, numerous suction holes (not shown in the drawing) are formed in a predetermined pattern in the peripheral surface of the image recording drum 52. The paper sheet P that has been wrapped onto the peripheral surface of the image recording drum 52 is sucked from the suction holes, whereby the paper sheet P is conveyed while being sucked and held on the peripheral surface of the image recording drum 52. Because of this, the paper sheet P can be conveyed with a high degree of smoothness.

The suction from the suction holes acts only in a fixed range and acts between a predetermined start-of-suction position and a predetermined end-of-suction position. The start-of-suction position is set in the installation position of the paper sheet holding roller 54, and the end-of-suction position is set on the downstream side of the installation position of the inline sensor 58 (e.g., the end-of-suction position is set in the position at which the image recording drum 52 transfers the paper sheet P to the ink drying treatment section 20). That is, the start-of-suction position and the end-of-suction position are set in such a way that the paper sheet P is sucked and held on the peripheral surface of the image recording drum 52 at least in the installation position of the inkjet heads 56M, 56K, 56C, and 56Y (which is an image recording position) and the installation position of the inline sensor 58 (which is an image reading position).

The mechanism by which the paper sheet P is sucked and held on the peripheral surface of the image recording drum 52 is not limited to the suction method resulting from negative pressure described above and can also employ a method resulting from electrostatic attraction.

Further, the image recording drum 52 of the present example is configured in such a way that the gripper 52A is disposed in two places on the outer peripheral surface so that two of the paper sheets P can be conveyed by one rotation. The rotation of the image recording drum 52 and the rotation of the process liquid drying treatment drum 46 are controlled in such a way that the timing of the receipt of the paper sheet P by the image recording drum 52 and the timing of the transfer of the paper sheet P by the process liquid drying treatment drum 46 coincide. That is, the image recording drum 52 and the process liquid drying treatment drum 46 are driven in such a way that they have the same circumferential speed and are driven in such a way that the positions of their respective grippers coincide.

The paper sheet holding roller 54 is disposed in the neighborhood of a paper sheet receiving position of the image recording drum 52 (the position at which the image recording drum 52 receives the paper sheet P from the process liquid drying treatment drum 46). The paper sheet holding roller 54 is configured by a rubber roller and is installed in such a way that it is pressed against and brought into contact with the peripheral surface of the image recording drum 52. The paper sheet P that has been transferred from the process liquid drying treatment drum 46 to the image recording drum 52 is nipped and brought into close contact with the peripheral surface of the image recording drum 52 as a result of passing through the paper sheet holding roller 54.

The four inkjet heads 56M, 56K, 56C, and 56Y are placed at fixed intervals apart from each other along the conveyance path of the paper sheet P resulting from the image recording drum 52.

The inkjet heads 56M, 56K, 56C, and 56Y are configured by line heads corresponding to the width of the paper sheets P and are placed in such a way that their nozzle surfaces oppose the peripheral surface of the image recording drum 52. The inkjet heads 56M, 56K, 56C, and 56Y jet liquid droplets of aqueous UV inks toward the image recording drum 52 from nozzle rows formed in their nozzle surfaces to thereby record an image on the paper sheet P conveyed by the image recording drum 52.

The inline sensor 58 is installed on the downstream side of the last inkjet head 56Y with respect to the conveyance direction of the paper sheet P resulting from the image recording drum 52 and reads the image that has been recorded by the inkjet heads 56M, 56K, 56C, and 56Y. The inline sensor 58 is configured by a line scanner, for example, and reads the image that has been recorded by the inkjet heads 56M, 56K, 56C, and 56Y from the paper sheet P conveyed by the image recording drum 52.

A contact prevention plate 59 is installed on the downstream side of the inline sensor 58 in proximity to the inline sensor 58. The contact prevention plate 59 prevents the paper sheet P from contacting the inline sensor 58 in a case where lift has occurred in the paper sheet P due to conveyance trouble or the like.

The mist filter 60 is disposed between the last inkjet head 56Y and the inline sensor 58 and sucks in the air around the image recording drum 52 to trap ink mist. In this way, by sucking in the air around the image recording drum 52 to trap ink mist, the ingress of ink mist into the inline sensor 58 can be prevented and the occurrence of reading defects and so forth can be prevented.

The drum cooling unit 62 blows cold air onto the image recording drum 52 to thereby cool the image recording drum 52. The drum cooling unit 62 is mainly configured by an air conditioner (not shown in the drawing) and a duct 62A that blows cold air supplied from the air conditioner onto the peripheral surface of the image recording drum 52. The duct 62A blows the cold air onto a region of the image recording drum 52 outside the region that conveys the paper sheet P to thereby cool the image recording drum 52. In the present example, the paper sheet P is conveyed along a circular arc surface substantially on the upper half of the image recording drum 52, so the duct 62A is given a configuration that blows the cold air onto the region of substantially the lower half of the image recording drum 52 to thereby cool the image recording drum 52. Specifically, the duct 62A is given a configuration where the air outlet of the duct 62A is formed in a circular arc shape in such a way as to cover substantially the lower half of the image recording drum 52 and the cold air is blown onto the region of substantially the lower half of the image recording drum 52.

<Ink Drying Treatment Section>

The ink drying treatment section 20 administers a drying treatment to the paper sheet P after image recording to remove the liquid component remaining on the recording surface of the paper sheet P. The ink drying treatment section 20 is mainly configured by a chain gripper 64 that conveys the paper sheet P on which the image has been recorded, a back tension application mechanism 66 that serves as an example of a back tension applying unit that applies back tension to the paper sheet P conveyed by the chain gripper 64, and ink drying treatment units 68 that serve as an example of drying units that administer a drying treatment to the paper sheet P conveyed by the chain gripper 64.

The chain gripper 64 is a paper sheet conveyance mechanism used in common by the ink drying treatment section 20, the UV irradiation treatment section 22, and the paper discharge section 24. The chain gripper 64 receives the paper sheet P that has been transferred from the image recording section 18 and conveys the paper sheet P to the paper discharge section 24.

The chain gripper 64 is mainly configured by a first sprocket 64A that is installed in proximity to the image recording drum 52, a second sprocket 64B that is installed in the paper discharge section 24, an endless chain 64C that is wrapped around the first sprocket 64A and the second sprocket 64B, plural chain guides (not shown in the drawing) that guide the travel of the chain 64C, and plural grippers 64D that are attached at fixed intervals apart from each other to the chain 64C. The first sprocket 64A, the second sprocket 64B, the chain 64C, and the chain guides are each configured in pairs and are disposed on both sides in the width direction of the paper sheet P. The grippers 64D are installed in such a way as to span the chains 64C disposed in a pair.

The first sprocket 64A is installed in proximity to the image recording drum 52 so that the paper sheets P transferred from the image recording drum 52 can be received by the grippers 64D. The first sprocket 64A is supported by an unillustrated bearing, is disposed in such a way that it may freely rotate, and is coupled to an unillustrated motor. The chain 64C wrapped around the first sprocket 64A and the second sprocket 64B travels as a result of the motor being driven.

The second sprocket 64B is installed in the paper discharge section 24 so that the paper sheet P that has been received from the image recording drum 52 can be collected by the paper discharge section 24. That is, the installation position of the second sprocket 64B is configured to be at the terminal end of the conveyance path of the paper sheet P resulting from the chain gripper 64. The second sprocket 64B is supported by an unillustrated bearing and is disposed in such a way that it may freely rotate.

The chain 64C is formed in an endless shape and is wrapped around the first sprocket 64A and the second sprocket 64B.

The chain guides are placed in predetermined positions and guide the chain 64C in such a way that the chain 64C travels a predetermined path (i.e., the chain guides guide the chain 64C in such a way that the paper sheet P travels and is conveyed on a predetermined conveyance path). In the inkjet recording apparatus 10 of the present example, the second sprocket 64B is disposed in a higher position than the first sprocket 64A. For this reason, a traveling path in which the chain 64C inclines midway is formed. Specifically, the traveling path is configured by a first horizontal conveyance path 70A, an inclined conveyance path 70B, and a second horizontal conveyance path 70C.

The first horizontal conveyance path 70A is set to the same height as the first sprocket 64A and is set in such a way that the chain 64C wrapped around the first sprocket 64A travels horizontally. The second horizontal conveyance path 70C is set to the same height as the second sprocket 64B and is set in such a way that the chain 64C wrapped around the second sprocket 64B travels horizontally. The inclined conveyance path 70B is set between the first horizontal conveyance path 70A and the second horizontal conveyance path 70C and is set in such a way as to join the first horizontal conveyance path 70A and the second horizontal conveyance path 70C.

The chain guides are disposed in such a way as to form the first horizontal conveyance path 70A, the inclined conveyance path 70B, and the second horizontal conveyance path 70C. Specifically, the chain guides are disposed at least in the points where the first horizontal conveyance path 70A and the inclined conveyance path 70B join to each other and in the points where the inclined conveyance path 70B and the second horizontal conveyance path 70C join to each other.

The grippers 64D are plurally attached at fixed intervals apart from each other to the chain 64C. The intervals at which the grippers 64D are attached are set in such a way as to correspond to the intervals at which the grippers 64D receive the paper sheets P from the image recording drum 52. That is, the intervals at which the grippers 64D are attached are set in correspondence to the intervals at which the grippers 64D receive the paper sheets P from the image recording drum 52 so that the grippers 64D can match the timing of, and receive from the image recording drum 52, the paper sheets P successively transferred from the image recording drum 52.

The chain gripper 64 is configured as described above. As mentioned above, when the motor (not shown in the drawing) connected to the first sprocket 64A is driven, the chain 64C travels. The chain 64C travels at the same speed as the circumferential speed of the image recording drum 52. Further, the timings are matched in such a way that the paper sheets P transferred from the image recording drum 52 can be received by the grippers 64D.

The back tension application mechanism 66 applies back tension to the paper sheet P that is conveyed with its leading end gripped by the chain gripper 64. The back tension application mechanism 66 is mainly equipped with a guide plate 72 (suction plate) and plural suction fans 73 that suck in air from numerous suction holes formed in the upper surface of the guide plate 72. Further, numerous holes for blowing out the sucked-in air are disposed in the lower surface of the guide plate 72.

The guide plate 72 is configured by a hollow box plate that has a width corresponding to the width of the paper sheets P. The guide plate 72 is disposed along the conveyance path of the paper sheet P resulting from the chain gripper 64 (i.e., the traveling path of the chain 64C). Specifically, the guide plate 72 is disposed along the chain 64C that travels the first horizontal conveyance path 70A and the inclined conveyance path 70B, and the guide plate 72 is disposed a predetermined distance apart from the chain 64C. The paper sheet P conveyed by the chain gripper 64 is conveyed with its back surface (the surface on the side on which the image is not recorded) sliding on and contacting the top of the upper surface (the surface opposing the chain 64C: a sliding contact surface) of the guide plate 72.

The numerous suction holes are formed in a predetermined pattern in the sliding contact surface (upper surface) of the guide plate 72. As mentioned above, the guide plate 72 is formed by a hollow box plate. The suction fans 73 suck air into the hollow portion (the inside) of the guide plate 72. Because of this, air is sucked in from the suction holes formed in the sliding contact surface.

Air is sucked in from the suction holes in the guide plate 72, whereby the back surface of the paper sheet P conveyed by the chain gripper 64 is sucked by the suction holes (sucked onto the guide plate 72). Because of this, back tension is applied to the paper sheet P conveyed by the chain gripper 64.

As mentioned above, the guide plate 72 is disposed along the chain 64C that travels the first horizontal conveyance path 70A and the inclined conveyance path 70B, so back tension is applied while the paper sheet P is conveyed on the first horizontal conveyance path 70A and the inclined conveyance path 70B. In the present embodiment, the suction fans 73 may be omitted so as not to apply back tension.

The ink drying treatment units 68 are installed inside the chain gripper 64 (particularly the posterior half side and the anterior half side of the site configuring the first horizontal conveyance path 70A) and administer the drying treatment with respect to the paper sheet P conveyed on the first horizontal conveyance path 70A. It is preferred that the ink drying treatment units 68 dry the paper sheet P in such a way that the water content on the paper sheet P including water in the aqueous UV inks becomes 3.0 g/m² or less before the application of ultraviolet light by the UV irradiation treatment section 22 by blowing dry air onto the recording surface of the paper sheet P conveyed on the first horizontal conveyance path 70A. This is so that the curability of the aqueous UV inks by the UV irradiation treatment section 22 can be improved in the apparatus configuration of the present embodiment.

Further, the ink drying treatment units 68 are plurally placed along the first horizontal conveyance path 70A. The number of the ink drying treatment units 68 that are installed is set in accordance with, for example, the processing capability of the ink drying treatment units 68 and the conveyance speed (i.e., the printing speed) of the paper sheet P. That is, the number of the ink drying treatment units 68 that are installed is set in such a way that the paper sheet P that has been received from the image recording section 18 can be dried while the paper sheet P is being conveyed on the first horizontal conveyance path 70A. Consequently, the length of the first horizontal conveyance path 70A is also set in consideration of the capability of the ink drying treatment units 68.

In order to inhibit excessive heating and insufficient heating of the paper sheet P by the ink drying treatment units 68, a temperature control mechanism 77 is provided inside the guide plate 72.

The temperature control mechanism 77 has a thermistor for measuring a temperature of the guide plate 72. When the mechanism determines that the temperature measured by the thermistor is higher than a standard value, cooling water flows, and when it determines that the temperature measured by the thermistor is lower than the standard value, the cooling water does not flow. As a result, the temperature of the guide plate 72, and furthermore the temperature of the paper sheet P are controlled to accurately prevent the deformation of the paper sheet and the lowering of the drying property. In addition, when the temperature control mechanism 77 is used, the temperature of the paper sheet can also be controlled depending on the paper thickness, and thus the robustness to the paper thickness can be enlarged.

<UV Irradiation Treatment Section>

The UV irradiation treatment section 22 applies ultraviolet (UV) light to the image that has been recorded using the aqueous UV inks to thereby fix the image. The UV irradiation treatment section 22 is mainly configured by the chain gripper 64 that conveys the paper sheet P, the back tension application mechanism 66 that applies back tension to the paper sheet P conveyed by the chain gripper 64, and UV irradiation units 74 that serve as an example of fixing units that apply ultraviolet light to the paper sheet P conveyed by the chain gripper 64.

As mentioned above, the chain gripper 64 and the back tension application mechanism 66 are also used in common by the ink drying treatment section 20 and the paper discharge section 24.

The UV irradiation units 74 are installed inside the chain gripper 64 (particularly in the site configuring the inclined conveyance path 70B) and apply ultraviolet light to the recording surface of the paper sheet P conveyed on the inclined conveyance path 70B. The UV irradiation units 74 are equipped with ultraviolet lamps (UV lamps) and are plurally disposed along the inclined conveyance path 70B. Additionally, the UV irradiation units 74 apply the ultraviolet light toward the recording surface of the paper sheet P conveyed on the inclined conveyance path 70B. The number of the UV irradiation units 74 that are installed is set in accordance with, for example, the conveyance speed (i.e., the printing speed) of the paper sheet P. That is, the number of the UV irradiation units 74 that are installed is set in such a way that the image can be fixed by the ultraviolet light that has been applied while the paper sheet P is being conveyed on the inclined conveyance path 70B. Consequently, the length of the inclined conveyance path 70B is also set in consideration of the conveyance speed of the paper sheet P and so forth.

<Paper Discharge Section>

The paper discharge section 24 collects the paper sheets P on which the series of image recording processes has been performed. The paper discharge section 24 is mainly configured by the chain gripper 64 that conveys the paper sheets P that have been irradiated with ultraviolet light and a paper discharge tray 76 that stacks and collects the paper sheets P.

As mentioned above, the chain gripper 64 is also used in common by the ink drying treatment section 20 and the UV irradiation treatment section 22. The chain gripper 64 releases the paper sheets P above the paper discharge tray 76 and stacks the paper sheets P in the paper discharge tray 76.

The paper discharge tray 76 stacks and collects the paper sheets P that have been released from the chain gripper 64. Paper guides (a front paper guide, a rear paper guide, lateral paper guides, etc.) are disposed on the paper discharge tray 76 so that the paper sheets P are stacked in an orderly manner (not shown in the drawing).

Further, the paper discharge tray 76 is disposed in such a way that it can be raised and lowered by an unillustrated paper discharge tray raising-and-lowering device. The driving of the paper discharge tray raising-and-lowering device is controlled in conjunction with increases and decreases in the number of the paper sheets P stacked in the paper discharge tray 76. The paper discharge tray raising-and-lowering device raises and lowers the paper discharge tray 76 in such a way that the paper sheet P positioned in the uppermost position is always positioned at a fixed height.

—Curable Ink Composition—

Next, an aqueous UV ink (curable ink composition) used in the present embodiment will be explained. The aqueous UV ink refers to a curable ink composition which is curable by ultraviolet light irradiation.

The curable ink composition is an aqueous curable ink composition including water as a medium, and includes a pigment, a polyfunctional polymerizable compound, and water. Optionally, the curable ink composition may further include other components such as polymer particles, a water-soluble organic solvent, a surfactant and a wetting agent.

<Pigment>

The curable ink composition includes at least one kind of a pigment. The pigment is not particularly limited, and may be arbitrarily selected according to the purpose. For example, any of organic pigments and inorganic pigments may be used. A pigment that is almost insoluble or slightly soluble in water is preferable in terms of the ink colorability.

Examples of organic pigments may include azo pigments, polycyclic pigments, dye chelates, nitro pigments, nitroso pigment, aniline black, and the like. Of these, the azo pigments and polycyclic pigments are more preferable. Examples of inorganic pigments may include titanium oxide, iron oxide, calcium carbonate, barium sulfate, aluminum hydroxide, barium yellow, cadmium red, chrome yellow, carbon black, and the like. Of these, carbon black is particularly preferable.

The pigment may be used alone or as a mixture of two or more thereof.

A content of the pigment in the curable ink composition is preferably from 1 to 25% by mass with respect to the curable ink composition, in terms of the image density, and more preferably from 2 to 15% by mass.

A dye may be used instead of the pigment. In a case in which the dye is used, a dye supported on a water-insoluble carrier may be used. The carrier on which the dye is supported (water-insoluble coloring particles) may be used as an aqueous dispersion which is obtained by using a dispersant. Dispersants described below may be preferably used as the dispersant.

<Dispersant>

The curable ink composition may include at least one kind of a dispersant. As the dispersant used for the pigment, either a polymer dispersant or a surfactant dispersant having a low molecular weight may be used. In addition, as the polymer dispersant, either a water-soluble dispersant or a water-insoluble dispersant may be used.

The surfactant dispersant having a low molecular weight has a structure including a hydrophilic group and a hydrophobic group. One or more hydrophilic groups and one or more hydrophobic groups may be each independently included in one molecule, and plural kinds of hydrophilic groups and hydrophobic groups may be included therein. The molecule may have a linking group for linking the hydrophilic group to the hydrophobic group.

Of the polymer dispersants, a water-soluble dispersant may be a hydrophilic polymer compound. Example of the natural hydrophilic polymer compound may include vegetable polymers such as gum arabic, gum tragacanth, guar gum, karaya gum, locust bean gum, arabinogalactan, pectin, and quince seed starch; seaweed polymers such as alginic acid, carrageenan, and agar-agar; animal polymers such as gelatin, casein, albumin, and collagen; microorganism polymers such as xanthan gum and dextran, and the like.

In addition, examples of hydrophilic polymer compounds which are obtained by modifying a natural product may include cellulose polymers such as methyl cellulose, ethyl cellulose, hydroxyethyl cellulose, hydroxypropyl cellulose, and carboxymethyl cellulose; starch polymers such as sodium starch glycolate and sodium starch phosphate; seaweed polymers such as sodium alginate and propylene glycol alginate, and the like.

Furthermore, examples of hydrophilic synthetic polymer compounds may include vinyl polymers such as polyvinyl alcohol, polyvinyl pyrrolidone, and polyvinyl methyl ether; acrylic resins such as non-crosslinked polyacrylamide, polyacrylic acid and alkali metal salts thereof, and water-soluble styrene-acrylic resins; water-soluble styrene-maleic acid resins, water-soluble vinylnaphthalene-acrylic resins, water-soluble vinylnaphthalene-maleic acid resins, polyvinylpyrrolidone, polyvinyl alcohol, alkali metal salts of a formalin condensate of β-naphthalenesulfonic acid, polymer compounds having a salt of a cationic functional group such as a quaternary ammonium or amino group in its side chains, natural polymer compounds such as shellac, and the like.

Of the polymer dispersants, as the water-insoluble dispersant, polymers having both hydrophobic moieties and hydrophilic moieties may be used. Examples thereof may include, styrene-(meth)acrylic acid copolymers, styrene-(meth)acrylic acid-(meth)acrylate copolymers, (meth)acrylate-(meth)acrylic acid copolymers, polyethylene glycol (meth)acrylate-(meth)acrylic acid copolymers, vinyl acetate-maleic acid copolymers, styrene-maleic acid copolymers, and the like.

A mixed mass ratio of the pigment (p) to the dispersant (s) (p:s) is preferably within a range of from 1:0.06 to 1:3, more preferably from 1:0.125 to 1:2, further more preferably from 1:0.125 to 1:1.5.

<Polymerizable Compound>

The curable ink composition in the present embodiment includes at least one kind of a polyfunctional polymerizable compound. The curable ink composition in the present embodiment includes water, and thus the polymerizable compound is preferably water-soluble.

Being water-soluble refers to being soluble in water in a certain concentration or more, and it may be being soluble in an aqueous ink or a process liquid in some cases. Specifically, a solubility in water is preferably 10% by mass or more, more preferably 15% by mass or more.

The curable ink composition in the present embodiment includes 3% by mass to 18% by mass, based on the total amount of the curable ink composition (hereinafter referred to as “total amount of the ink composition”), of the polyfunctional polymerizable compound. The content of the polyfunctional polymerizable compound in the curable ink composition can be quantitatively measured according to an analysis method such as liquid chromatography.

When the curable ink composition includes only less than 3% by mass, based on the total amount of the ink composition, of the polyfunctional polymerizable compound, the curability of the aqueous UV ink is insufficient. If the curability is insufficient, the image damage and the stain on the conveyance surface cannot be inhibited (the image damage and the stain on the conveyance surface occur), when the image on the paper sheet P is rubbed with the conveyance surface (the guide plate 72) during conveyance by the chain gripper 64 in the duplex printing.

In particular, when the back surface of the paper sheet P, which is conveyed by the chain gripper 64, is sucked by the suction holes, the image on the paper sheet P is completely rubbed with the conveyance surface. Thus, when only less than 3% by mass of the polyfunctional polymerizable compound is included, the image damage and the stain on the conveyance surface markedly occur. In addition, when only less than 3% by mass of the polyfunctional polymerizable compound is included, the stains on the process liquid application drum 42, the application roller 44A, the image recording drum 52, and the paper sheet holding roller 54 cannot be inhibited, during the duplex printing.

When the curable ink composition includes more than 18% by mass, based on the total amount of the ink composition, of the polyfunctional polymerizable compound, the deformation of the paper sheet such as shrinkage curling, which occurs during the ink-curing by the UV irradiation, cannot be inhibited (the deformation of the paper sheet occurs).

In the inkjet recording apparatus 10 of the present embodiment described above, the curable ink composition includes 3% by mass to 18% by mass, based on the total amount of the curable ink composition, of the polyfunctional polymerizable compound. As a result, the inhibition of the image damage and the stain on the conveyance surface during the duplex printing, and the inhibition of the paper sheet deformation during the printing are both achieved. In order to perform the duplex printing in the inkjet recording apparatus 10 of the present embodiment, the paper sheet P stacked in the paper discharge tray 76, whose one surface has been printed, is taken out, turned over, and stacked in the paper feed tray 30, and the printing is started.

The curable ink composition in the present embodiment includes preferably 15% by mass or less, based on the total amount of the ink composition, of the polyfunctional polymerizable compound. In such a case, the paper sheet deformation such as shrinkage curling, which occurs when the ink is cured by the UV irradiation, can be further inhibited.

In a case in which the back surface of the paper sheet P, which is conveyed by the chain gripper 64, is sucked by the suction holes, it is preferable that the polyfunctional polymerizable compound is included in an amount of 5% by mass or more based on the total amount of the ink composition. In such a case, the image damage and the stain on the conveyance surface during the duplex printing can be further inhibited.

In addition, in the case in which the back surface of the paper sheet P, which is conveyed by the chain gripper 64, is sucked by the suction holes, it is preferable that the polyfunctional polymerizable compound is included in an amount of 10% by mass or more based on the total amount of the ink composition. In such a case, the image damage during the duplex printing can be still further inhibited.

Furthermore, in the case in which the back surface of the paper sheet P, which is conveyed by the chain gripper 64, is sucked by the suction holes, it is preferable that the polyfunctional polymerizable compound is included in an amount of 15% by mass or more based on the total amount of the ink composition. In such a case, the image damage during the duplex printing can be eliminated.

The polyfunctional polymerizable compound may be a monomer, a polymer or the like so long as it has plural polymerizable groups in its molecule, and polyfunctional polymerizable monomers are preferable in terms of the ink jetting property in image formation, the maintenance, and the like.

As the polyfunctional polymerizable monomer, nonionic or cationic polymerizable compounds are preferable, because they do not inhibit, for example, a reaction of a aggregating component with a pigment or, in some cases, polymer particles, and polymerizable compounds having a solubility in water of 10% by mass or more (more preferably 15% by mass or more) are preferable.

Examples of nonionic polymerizable monomers may include polymerizable compounds such as (meth)acrylic monomers. Examples of (meth)acrylic monomers may include ultraviolet curable monomers and oligomers such as (meth)acrylates of a polyhydric alcohol, (meth)acrylates of a glycidyl ether of a polyhydric alcohol, (meth)acrylates of polyethylene glycol, (meth)acrylates of an ethylene oxide addition compound of a polyhydric alcohol, and reaction products of a polybasic acid anhydride with a hydroxyl group-containing (meth)acrylate. The polyhydric alcohols described above may be polyhydric alcohols having therein an ethylene oxide chain formed by addition of ethylene oxide.

Acrylic esters having two or more acryloyl groups in one molecule, which are derived from a compound having plural hydroxyl groups, may also be used. Examples of the compound having plural hydroxyl groups may include condensation products, oligoethers, and oligoesters of glycols.

As the nonionic polymerizable compound, (meth)acrylates of a polyol having two or more hydroxyl groups such as monosaccharide or disaccharide, and (meth)acrylates with triethanolamine, diethanolamine, trishydroxyaminomethane, or trishydroxyaminoethane may also be preferable

Examples of the preferable nonionic polymerizable compound may also include polyfunctional (meth)acrylamide compound having a (meth)acrylamide structure in its molecule, represented by the following formula (1). This polyfunctional (meth)acrylamide compound is a compound having plural (meth)acrylamide structures in its molecule, and being polymerized by irradiation of an active energy ray. Polyfunctional (meth)acrylamides represented by the following formula (1) in which n is 2 or more have a high polymerizability and a high polymerization efficiency when an image is cured by irradiation of an active energy ray, and provide excellent abrasion resistance and scratch resistance to a formed image.

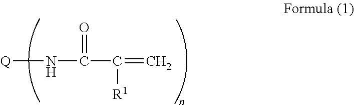

The compound represented by the formula (1) is a compound in which unsaturated vinyl monomers are bonded to a group Q through amide bonds. In the formula (1), Q represents an n-valent group, R¹ represents a hydrogen atom or a methyl group, and n represents an integer of 2 or more.

The group R¹ represents a hydrogen atom or a methyl group, preferably the hydrogen atom.

n is preferably 3, 4, or 5, that is, the polyfunctional (meth)acrylamide compound is preferably trifunctional, tetrafunctional, or pentafunctional, because image damage during duplex printing can be further inhibited. In particular, n is preferably 3 or 4, that is, the polyfunctional (meth)acrylamide compound is preferably trifunctional or tetrafunctional, because image damage during duplex printing can be still further inhibited.

When n is 2 or more, the group Q represents a linking group, and specific examples of the linking group Q may include, substituted or unsubstituted alkylene groups having 4 or less carbon atoms such as methylene, ethylene, propylene or butylene; bi- or higher valent linking group having a saturated or unsaturated heterocyclic ring (pyridine ring, imidazole ring, pyrazine ring, piperidine ring, piperazine ring, morpholine ring, and the like); a bi- or higher valent residue of a polyol compound including an oxyalkylene group (preferably an oxyethylene group); and a bi- or higher valent residue of a polyol compound including three or more oxyalkylene groups (preferably oxyethylene groups).

Specific examples of the (meth)acrylamide having a (meth)acrylamide structure in its molecule are shown below; however, the invention is not limited thereto.

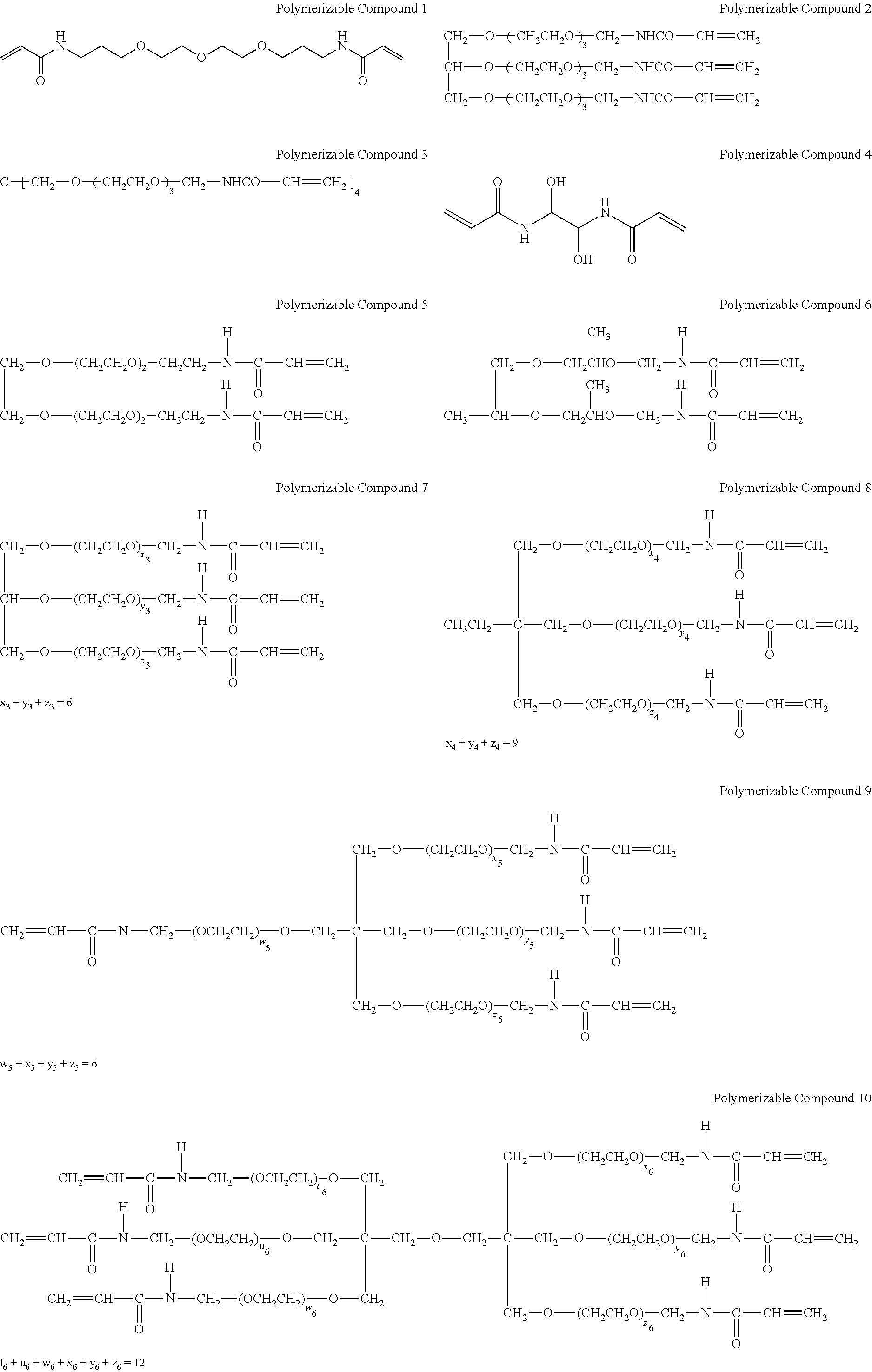

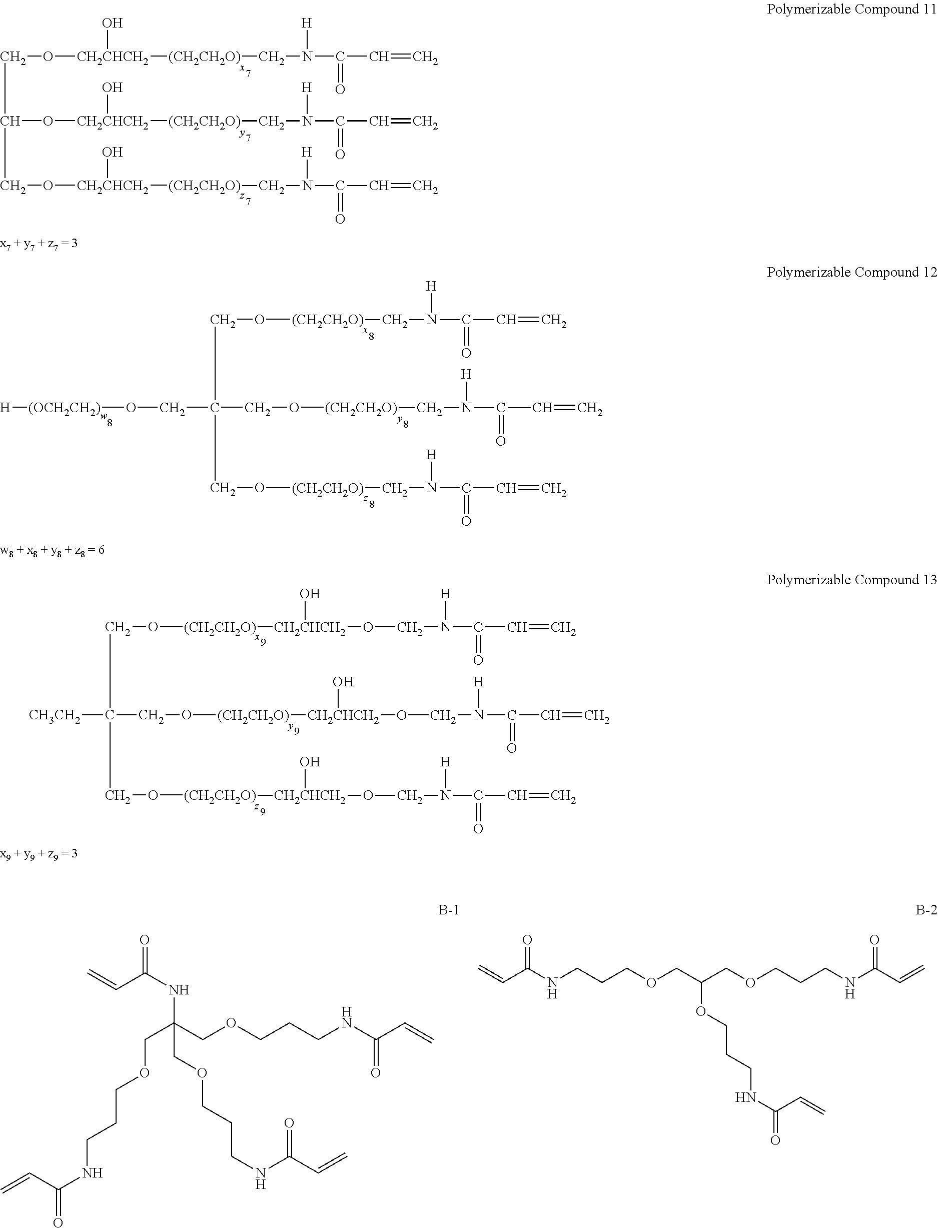

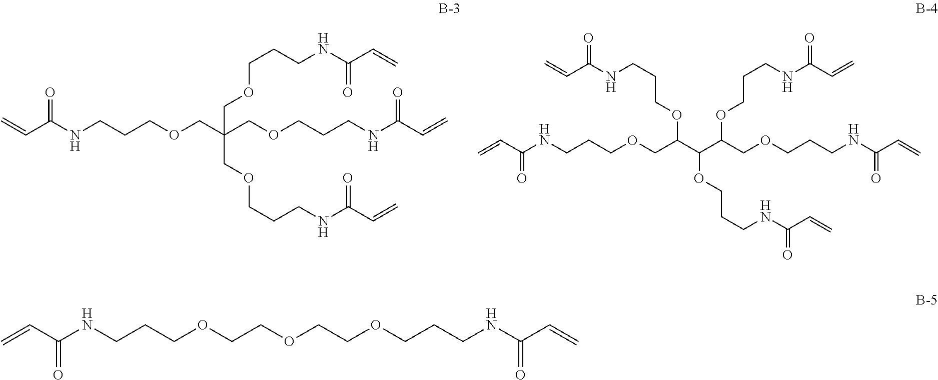 [SMILES: C=CC(=O)NCCCOCC(COCCCNC(=O)C=C)(COCCCNC(=O)C=C)COCCCNC(=O)C=C ; C=CC(=O)NCCCOCC(OCCCNC(=O)C=C)C(OCCCNC(=O)C=C)C(COCCCNC(=O)C=C)OCCCNC(=O)C=C ; C=CC(=O)NCCCOCCOCCOCCCNC(=O)C=C]

However, B-5 described above is the same as the polymerizable compound I described above.

In addition, compounds represented by the following formula (2) are preferable as the polyfunctional (meth)acrylamide compound, because of their high polymerizability and curability. This compound has four acrylamide groups or methacrylamide groups as the polymerizable groups in its molecule. This compound shows curability based on a polymerization reaction caused by applying active energy rays such as a-rays, y-rays, X-rays, ultraviolet rays, visible light rays, infrared rays or electron beams or energy such as heat.

The compounds represented by the following formula (2) show water-solubility and are sufficiently dissolved in water or a water-soluble organic solvent such as alcohol.

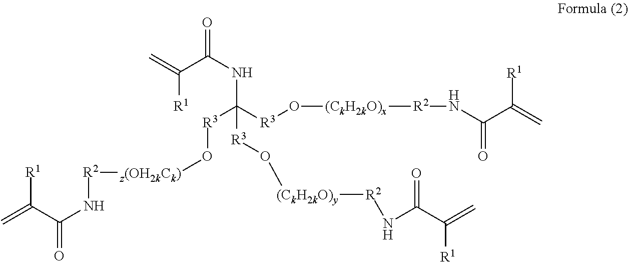

In the formula (2), R¹ represents a hydrogen atom or a methyl group, and the hydrogen atom is preferable. The plural R¹s may be the same as or different from each other.

R² represents a linear or branched alkylene group having 2 to 4 carbon atoms. The plural R²s may be the same as or different from each other. As R², alkylene group having 3 or 4 carbon atoms is preferable, alkylene group having 3 carbon atoms is more preferable, and a linear alkylene group having 3 carbon atoms is particularly preferable. The alkylene group R² may have a substituent, and the substituents may include an aryl group, an alkoxy group, and the like.

However, R² does not have a structure in which an oxygen atom and a nitrogen atom, which are attached to both ends of R², are bonded to the same carbon atom in R². R² is a linear or branched alkylene group which links an oxygen atom to a nitrogen atom in the (meth)acrylamide group. Here, when the alkylene group has a branched structure, it can be considered to form a —O—C—N— structure (a hemiaminal structure) in which an oxygen atom and a nitrogen atom in a (meth)acrylamide group are bonded to the same carbon atom in the alkylene group, but the compounds represented by the formula (2) do not include such a compound. The compound having the —O—C—N— structure in its molecule is easily decomposed at the position of the carbon atom. The compound, thus, is easily decomposed during storage, and is not preferable because the compound causes the deterioration of the storage stability when it is included in the curable ink composition.

R³ represents a bivalent linking group, and the plural R³s may be the same as or different from each other. Examples of the bivalent linking group represented by R³ may include an alkylene group, an arylene group, a heterocyclic group or combinations thereof, and the alkylene group is preferable. When the bivalent linking group includes the alkylene group, the alkylene group may further include at least one selected from —O—, —S— or —NR^{B}—. R^{B} represents a hydrogen atom or an alkyl group having 1 to 4 carbon atoms.

When R³ includes an alkylene group, examples of the alkylene group may include a methylene group, an ethylene group, a propylene group, a butylene group, a pentylene group, a hexylene group, a heptylene group, an octylene group, a nonylene group, and the like. The alkylene group in R³ includes preferably 1 to 6 carbon atoms, more preferably 1 to 3 carbon atoms, particularly preferably one carbon atom. The alkylene group in R³ may further include at least one selected from —O—, —S— or —NR^{B}—. Example of the alkylene group including —O— may include —C₂H₄—O—C₂H₄—, —C₃H₆—O—C₃H₆—, and the like. The alkylene group in R³ may further have a substituent, and examples of the substituent may include an aryl group, an alkoxy group, and the like.

When R³ includes an arylene group, examples of the arylene group may include a phenylene group, a naphthylene group, and the like. The arylene group in R³ includes preferably 6 to 14 carbon atoms, more preferably 6 to 10 carbon atoms, particularly preferably 6 carbon atoms. The arylene group may further have a substituent, and examples of the substituent may include an alkyl group, an alkoxy group, and the like.

When R³ includes a heterocyclic group, a 5-membered or 6-membered ring is preferable as the heterocyclic group, which may be a fused ring. The heterocyclic ring may be an aromatic heterocyclic ring or a non-aromatic heterocyclic ring. Examples of the heterocyclic group may include, pyridine, pyrazine, pyrimidine, pyridazine, triazine, quinoline, isoquinoline, quinazoline, cinnoline, phthalazine, quinoxaline, pyrrole, indole, furan, benzofuran, thiophene, benzothiophene, pyrazole, imidazole, benzimidazole, triazole, oxazole, benzoxazole, thiazole, benzothiazole, isothiazole, benzisothiazole, thiadiazole, isoxazole, benzisoxazole, pyrrolidine, piperidine, piperazine, imidazolidine, thiazoline, and the like. Of these, the aromatic heterocyclic groups are preferable, and pyridine, pyrazine, pyrimidine, pyridazine, triazine, pyrazole, imidazole, benzimidazole, triazole, thiazole, benzothiazole, isothiazole, benzisothiazole and thiadiazole are preferable. The heterocyclic group shown above is described in a state in which the substitution position is omitted, but the substitution position is not limited, and the pyridine, for example, may be substituted at the 2-position, 3-position or 4-position, and it may include all of the substituted forms.

The heterocyclic group may further have a substituent, and examples of the substituent may include an alkyl group, an aryl group, an alkoxy group, and the like.

In the formula (2) described above, k represents 2 or 3. The plural ks may be the same as or different from each other. CₖH₂ₖ may be a linear structure or a branched structure.

Each of x, y and z independently represents an integer of 0 to 6, and an integer of 0 to 5 is preferable and an integer of 0 to 3 is more preferable. x+y+z is from 0 to 18, it is preferable that x+y+z is from 0 to 15, and it is more preferable that x+y+z is from 0 to 9.

Of the compounds described above, compounds in which R¹ represents the hydrogen atom or methyl group, R² represents the alkylene group having 3 or 4 carbon atoms, R³ represents the alkylene group having 1 to 6 carbon atoms (preferably 1 to 3 carbon atoms), k represents 2 or 3, x, y and z each independently represent an integer of 0 to 6, and x+y+z is 0 to 15 are preferable.

Specific examples of the compounds represented by the formula (2) described above are shown below. The invention, however, is not limited thereto.

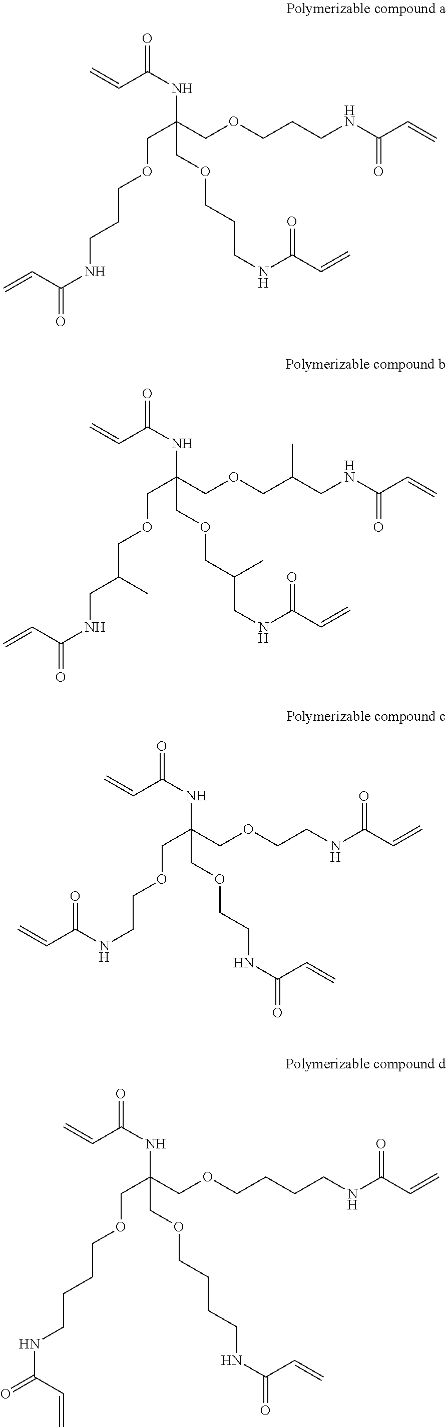

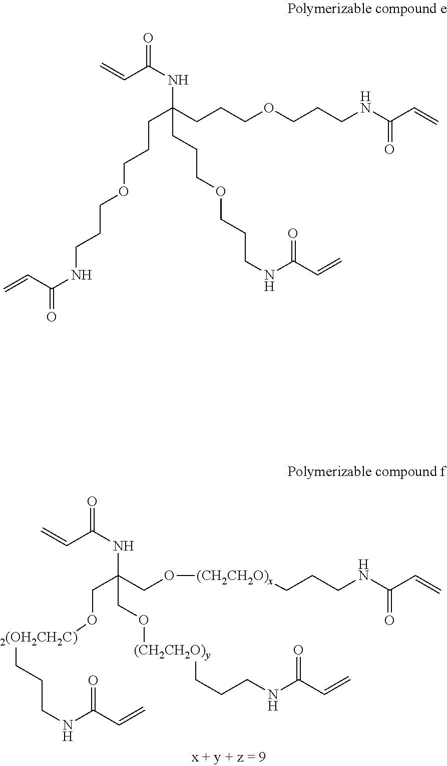

The compound represented by the formula (2) can be produced according to, for example, Scheme 1 or Scheme 2.

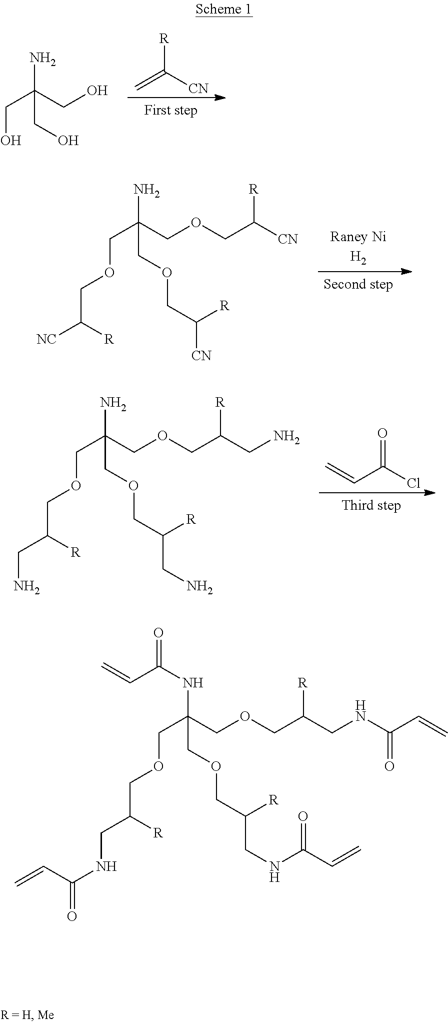

In Scheme 1, the first step is a step in which a polycyano compound is obtained by a reaction of acrylonitrile with trishydroxymethylaminomethane. In this step, the reaction is preferably performed at 3 to 60° C. for 2 to 8 hours.

The second step is a step in which a polyamine compound is obtained by a reduction reaction of reacting the polycyano compound with hydrogen in the presence of a catalyst. In this step, the reaction is preferably performed at 20 to 60° C. for 5 to 16 hours.

The third step is a step in which a polyfunctional (meth)acrylamide compound is obtained by an acylation reaction of the polyamine compound with acrylic acid chloride or methacrylic acid chloride. In this step, the reaction is preferably performed at 3 to 25° C. for 1 to 5 hours. A diacrylic acid anhydride or dimethacrylic acid anhydride may be used instead of the acid chloride as the acylating agent. In the acylation step, when both of the acrylic acid chloride and the methacrylic acid chloride are used, a compound having an acrylamido group and a methacrylamido group in the same molecule can be obtained as the final product.

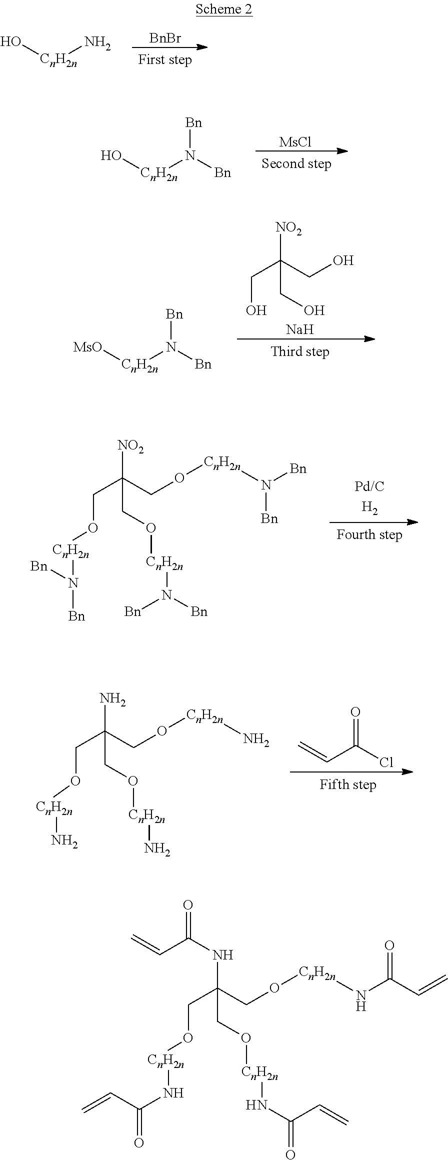

In Scheme 2 described above, the first step is a step in which an aminoalcohol compound having a protected nitrogen is obtained by introducing a protective group such as a benzyl group or a benzyloxycarbonyl group to a nitrogen atom in the aminoalcohol. The reaction in this step is preferably performed at 3 to 25° C. for 3 to 5 hours.

The second step is a step in which a sulfonyl compound is obtained by introducing a leaving group such as a methanesulfonyl group or a p-toluenesulfonyl group to an OH group of the aminoalcohol compound having the protected nitrogen. The reaction in this step is preferably performed at 3 to 25° C. for 2 to 5 hours.

The third step is a step in which a compound to which the aminoalcohol is added is obtained by an SN2 reaction of a sulfonyl compound with trishydroxymethylnitromethane. The reaction in this step is preferably performed at 3 to 70° C. for 5 to 10 hours.

The fourth step is a step in which a polyamine compound is obtained by hydrogenation reaction of the compound to which the aminoalcohol is added with hydrogen in the presence of a catalyst. The reaction in this step is preferably performed at 20 to 60° C. for 5 to 16 hours.

The fifth step is a step in which a polyfunctional (meth)acrylamide compound is obtained by an acylation reaction of the polyamine compound with an acrylic acid chloride or methacrylic acid chloride. The reaction in this step is preferably performed at 3 to 25° C. for 1 to 5 hours. A diacrylic acid anhydride or dimethacrylic acid anhydride may be used instead of the acid chloride as the acylating agent. In the acylation step, when both of the acrylic acid chloride and the methacrylic acid chloride are used, a compound having an acrylamido group and a methacrylamido group in the same molecule can be obtained as the final product.

The compound, which is formed through the steps described above, can be obtained by purifying the reaction product liquid in a usual manner. For example, the purification may be performed by, for example, a separation extraction using an organic solvent, a crystallization using a poor solvent, a column chromatography using silica gel, or the like.

A cationic polymerizable compound, which is an example of the polymerizable compounds, is a compound having a cationic group and a polymerizable group such as unsaturated double bond. Preferable cationic polymerizable compounds may include, for example, epoxy monomers, oxetane monomers, and the like. In a case in which the cationic polymerizable compound is included, the cationic property of the curable ink composition becomes strong because the cationic group is included, and thus color mixing can be more effectively prevented when an anionic ink is used.

Examples of the cationic polymerizable compounds described above may include N,N-dimethylaminoethyl methacrylate, N,N-dimethylaminoethyl acrylate, N,N-dimethylaminopropyl methacrylate, N,N-dimethylaminopropyl acrylate, N,N-dimethylaminoacrylamide, N,N-dimethylaminomethacrylamide, N,N-dimethylaminoethyl acrylamide, N,N-dimethylaminoethyl methacrylamide, N,N-dimethylaminopropyl acrylamide, N,N-dimethylaminopropyl methacrylamide, quaternized compounds thereof, and the like. Examples of the epoxy monomers described above may include glycidyl ethers of a polyhydric alcohol, glycidyl esters, alicyclic epoxides, and the like.

Examples of cationic polymerizable compounds may include compounds having the following structures.

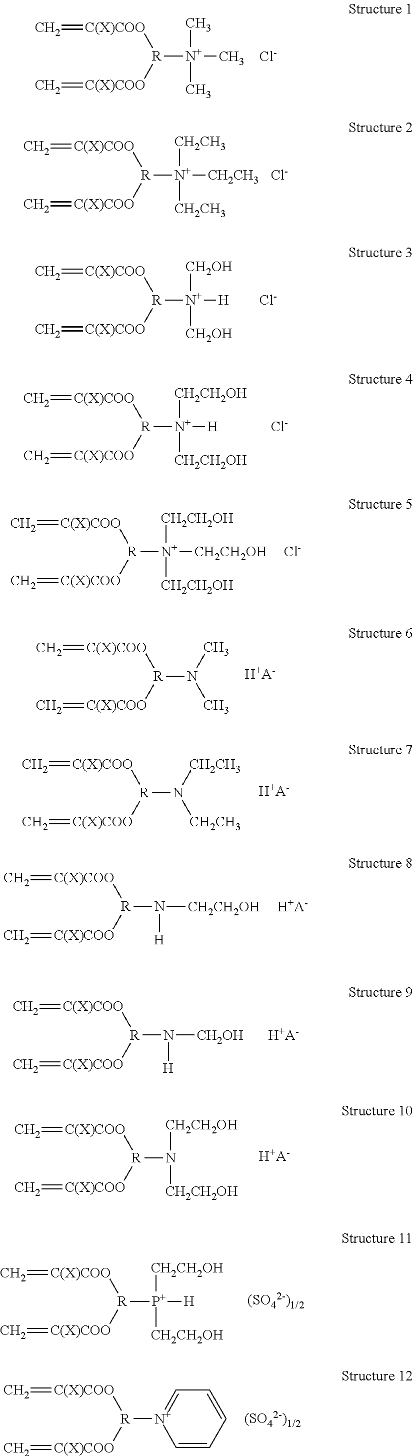

In the structures described above, R represents a residue of a polyol. X represents H or CH₃; and A⁻ represents Cl⁻, HSO₃⁻ or CH₃COO⁻. Examples of compounds, which are used for introducing this polyol, may include glycerin, 1,2,4-butanetriol, 1,2,5-pentanetriol, 1,2,6-hexanetriol, trimethylol propane, trimethylol methane, trimethylol ethane, pentaerythritol, bisphenol A, alicyclic bisphenol A, and condensation products thereof, and the like.

Specific examples of polymerizable compounds including a cationic group (cationic compounds 1 to 11) are shown below.

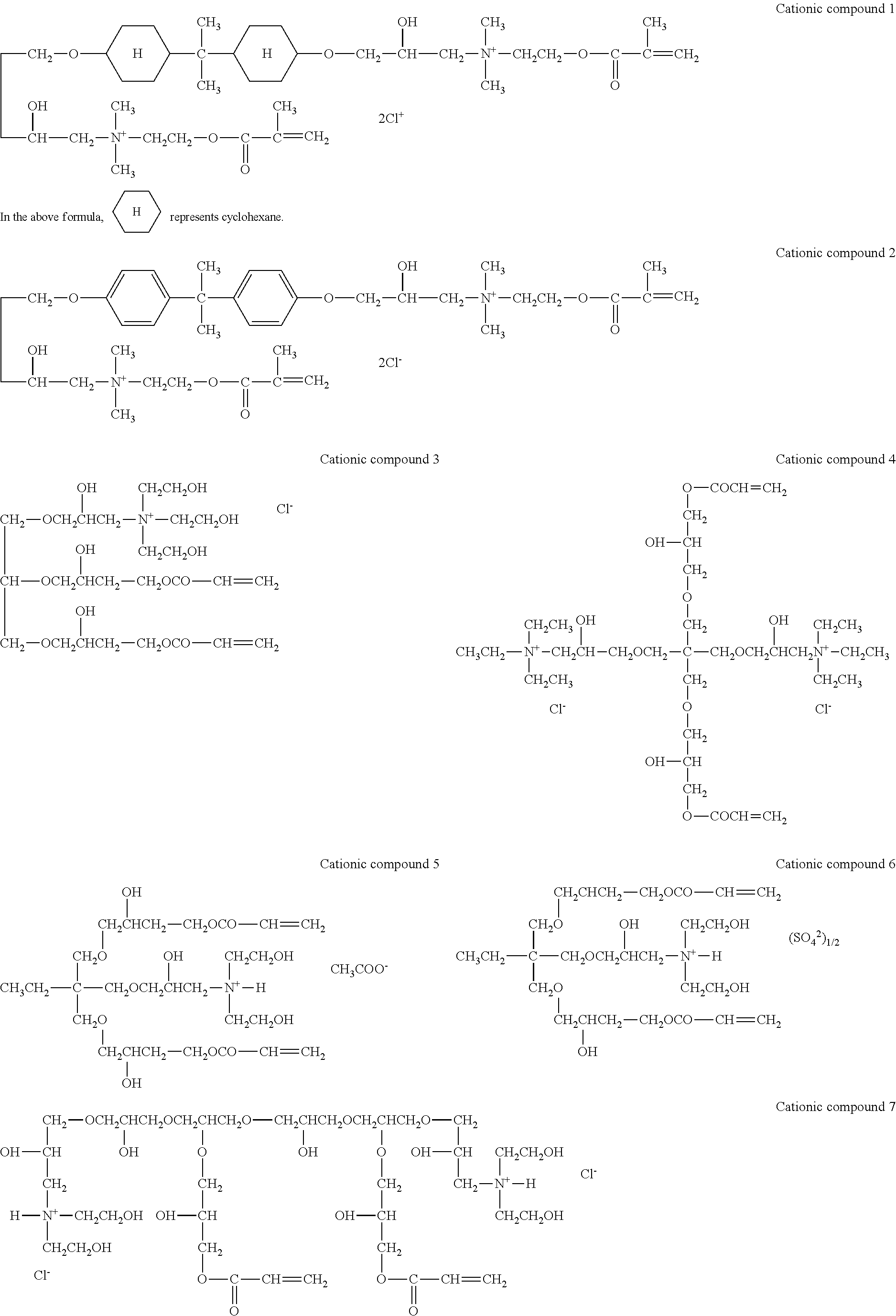

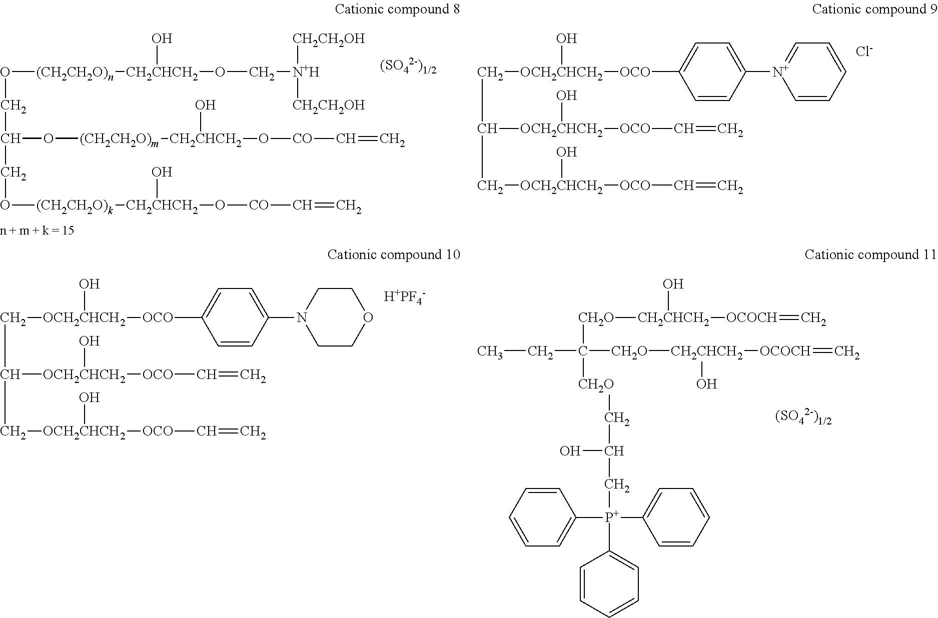

In the present embodiment, an embodiment in which the polyfunctional polymerizable compound is used in combination with a monofunctional polymerizable compound is also preferable. When the monofunctional polymerizable compound is included, an ink having excellent permeability into a pigment layer in a coated paper can be obtained, whereby not only the image but also the pigment layer are cured, thus resulting in more increased adhesion.

Examples of the monofunctional polymerizable compounds may include monomers such as (meth)acrylic acid and esters thereof, and (meth)acrylamide. The (meth)acrylamide may include, for example, hydroxyethyl acrylamide.

<Polymerization Initiator>

The curable ink composition in the present embodiment may include at least one kind of a polymerization initiator capable of initiating polymerization of polymerizable compounds by active energy rays, which may also be included or not included in the process liquid described above. The polymerization initiator may be used alone or as a mixture of two or more kinds thereof, or may be used together with a sensitizer.

A compound which is capable of initiating a polymerization reaction of polymerizable compounds by active energy rays is arbitrarily selected, and the compound may be included as the polymerization initiator. Examples of the polymerization initiators may include polymerization initiators capable of generating active species (a radical, an acid, a base, and the like) by radial rays, light, or electron beam (for example, a photopolymerization initiator, and the like).

Examples of the photopolymerization initiators may include acetophenone,
2,2-diethoxyacetophenone, p-dimethylaminoacetophenone, p-dimethylaminopropiophenone, benzophenone, 2-chlorobenzophenone, p,p′-dichlorobenzophenone, p,p′-bisdiethylaminobenzophenone, Michler's ketone, benzil, benzoin, benzoin methyl ether, benzoin ethyl ether, benzoin isopropyl ether, benzoin n-propyl ether, benzoin isobutyl ether, benzoin n-butyl ether, benzyl dimethyl ketal, tetramethylthiurammonosulfide, thioxanthone, 2-chlorothioxanthone, 2-methyl thioxanthone, azobisisobutyronitrile, benzoin peroxide, di-tert-butyl peroxide, 1-hydroxycyclohexyl phenyl ketone, 1-[4-(2-hydroxyethoxy)-phenyl]-2-hydroxy-2-methyl-1-propan-1-one, 2-hydroxy-2-methyl-1-phenyl-1-one, 1-(4-isopropylphenyl)-2-hydroxy-2-methylpropan-1-one, and methylbenzoyl formate.

<Water>

The curable ink composition in the present embodiment includes water, and the amount thereof is not particularly limited. The preferable water content is, inter alia, from 10 to 99% by mass.

<Water-Soluble Organic Solvent>

The curable ink composition in the present embodiment may include a water-soluble organic solvent.

Due to the water-soluble organic solvent, effects of prevention of drying, wetting or enhancing of penetration to the paper sheet can be obtained in the curable ink composition. Examples of the water-soluble organic solvent, which can be included in the curable ink composition, may include glycerin, 1,2,6-hexane triol, trimethylol propane, glycols such as ethylene glycol, propylene glycol, diethylene glycol, triethylene glycol, tetraethylene glycol, pentaethylene glycol, and dipropylene glycol, and polyhydric alcohols such as alkane diols including 2-butene-1,4-diol, 2-ethyl-1,3-hexanediol, 2-methyl-2,4-pentanediol, 1,2-octanediol, 1,2-hexanediol, 1,2-pentanediol, and 4-methyl-1,2-pentanediol, and, in addition, saccharides and sugar alcohols, hyaluronic acids, C₁₋₄ alkyl alcohols, glycol ethers, 2-pyrrolidone, and N-methyl-2-pyrrolidone described in JP-A No. 2011-42150, paragraph [0116], and alkylene oxide adducts of glycerin described in JP-A No. 2011-42150, paragraphs [0121] to [0125], and the like. These solvents may be used alone or as a mixture of two or more kinds arbitrarily selected. The polyhydric alcohols are useful as an agent of preventing drying or a wetting agent, and JP-A No. 2011-42150 describes examples thereof in paragraph [0117]. The polyol compounds are preferable as penetrating agent, and examples of aliphatic diols are described in, for example, JP-A No. 2011-42150, paragraph [0117].

—Polymer Particle—

The curable ink composition in the present embodiment may include at least one kind of polymer particles. The polymer particles have a function of fixing the curable ink composition by having a destabilized dispersion state, aggregating, and becoming thick in the curable ink composition, when they are brought into contact with the process liquid described above or the dried area thereof, and thus they can more improve the adhesion property of the curable ink composition to the recording medium and the scratch resistance of the image.

The curable ink composition in the present embodiment can include the polymer particles, in terms of the aggregation speed when the process liquid is used in the image formation or the glossiness of the image formed. The polymer particles may be used alone or as a mixture of two or more kinds thereof.

As the polymer particles, for example, a latex in which a particulate polymer is dispersed in an aqueous medium may be used. As the polymer, acrylic resins, vinyl acetate resins, styrene-butadiene resins, vinyl chloride resins, acrylic styrene resins, butadiene resins, styrene resins, crosslinked acrylic resins, crosslinked styrene resins, benzoguanamine resins, phenol resins, silicone resins, epoxy resins, urethane resins, paraffin resins, and fluorine-containing resins may be used. Of these, preferable examples may include acrylic resins, acrylic styrene resins, styrene resins, crosslinked acrylic resins, and crosslinked styrene resin.

The aqueous medium includes water, and if necessary may include a hydrophilic organic solvent. In the present embodiment, the aqueous medium is preferably formed by using water and 0.2% by mass or less of the hydrophilic organic solvent, and an aqueous medium consisting of water is more preferable.

Among the polymer particles, self-dispersible polymer particles are preferable. The particles of the self-dispersible polymer refer to particles of a water-insoluble polymer which include no free emulsifier, and can have a dispersion state in an aqueous medium due to the functional group (in particular, an acidic group or a salt thereof) in the polymer itself, when the particles are dispersed (in particular, dispersed by a phase-transfer emulsification method) in absence of a surfactant. The particles of the self-dispersible polymer are preferable in terms of the jetting stability and the liquid stability of a system including the pigment described above (in particular, the dispersion-stability).

Here, the dispersion states include both an emulsification state in which the water-insoluble polymer is dispersed in a liquid state in the aqueous medium (an emulsion) and a dispersion state in which the water-insoluble polymer is dispersed in a solid state in the aqueous medium (a suspension). The water-insoluble polymer in the invention is preferably a water-insoluble polymer capable of having a dispersion state in which the water-insoluble polymer is dispersed in a solid state, in terms of the aggregation speed when a liquid composition is formed and the fixability.

A phase-transfer emulsification method may be used for producing an emulsification state or a dispersion state of the self-dispersible polymer, i.e., the aqueous dispersion of the self-dispersible polymer. Examples of the phase-transfer emulsification method may include a method in which after the self-dispersible polymer is dissolved or dispersed in a solvent (for example, hydrophilic organic solvents, and the like), the resulting product is fed into water as it is without adding a surfactant, which is stirred and mixed in a state in which groups capable of forming salts (for example, acidic groups) in the self-dispersible polymer are neutralized, and the solvent is removed therefrom to give an aqueous dispersion in the emulsion or dispersion state.

The dispersion state of the particles of the self-dispersible polymer refers to a state in which it can be visually confirmed that a dispersion state is stably maintained at 25° C. for at least one week, the dispersion state being obtained by mixing a solution of 30 g of the water-insoluble polymer dissolved in 70 g of the organic solvent (for example, methyl ethyl ketone), a neutralizer capable of neutralizing 100% of salt-forming groups in the water-insoluble polymer (sodium hydroxide in a case of an anionic salt-forming group, and acetic acid in a case of a cationic salt-forming group), and 200 g of water, stirring the mixture (a device: stirrer provided with a blade, the number of revolutions: 200 rpm, for 30 minutes, at 25° C.), and then removing the organic solvent from the mixed liquid.

The water-insoluble polymer refers to a polymer having a dissolution amount thereof of 10 g or less when the polymer is dried at 105° C. for 2 hours, and then it is dissolved in 100 g of water having a temperature of 25° C. The dissolution amount is preferably 5 g or less, more preferably 1 g or less. The dissolution amount described above is a dissolution amount when 100% of the salt-forming group is neutralized with sodium hydroxide or acetic acid according to the kind of the salt-forming group in the water-insoluble polymer.

The particles of the self-dispersible polymer in the present embodiment are described in detail in JP-A No. 2011-042150, paragraphs [0066] to [0113], and the descriptions can be referred in and applied to the invention.

The particles of the self-dispersible polymer in the present embodiment preferably include a water-insoluble polymer including hydrophilic structural units and structural units derived from an aromatic group-containing monomer, in terms of the self-dispersibility.

The hydrophilic structural unit is not particularly limited, so long as it is a repeating unit derived from a hydrophilic group-containing monomer. The hydrophilic group-containing monomer is preferably a dissociative group-containing monomer, in terms of the self-dispersibility and the aggregating property, and a dissociative group-containing monomer having a dissociative group and an ethylenically unsaturated bond is preferable. Examples of the dissociative group-containing monomer may include unsaturated carboxylic acid monomers, unsaturated sulfonic acid monomers, unsaturated phosphoric acid monomers, and the like. Specific examples of the unsaturated carboxylic acid monomer include acrylic acid, methacrylic acid, crotonic acid, itaconic acid, maleic acid, fumaric acid, citraconic acid, 2-methacryloyloxymethylsuccinic acid, and the like. Of the dissociative group-containing monomers, the unsaturated carboxylic acid monomers are preferable in terms of the dispersion-stability and jetting stability, acrylic monomers are more preferable, and acrylic acid and methacrylic acid are particularly preferable.

The aromatic group-containing monomer is not particularly limited, so long as it includes an aromatic group and a polymerizable group. The aromatic group-containing monomer is preferably a monomer having an aromatic group derived from an aromatic hydrocarbon and ethylenically unsaturated bond, and examples thereof may include phenoxyethyl (meth)acrylate, benzyl (meth)acrylate, phenyl (meth)acrylate, styrene monomers, and the like. Of these, the aromatic group-containing (meth)acrylate monomers are preferable in terms of the balance between the hydrophilicity and the hydrophobicity in the polymer chain and ink-fixation, at least one selected from the phenoxyethyl (meth)acrylate, benzyl (meth)acrylate, and phenyl (meth)acrylate is more preferable, and phenoxyethyl (meth)acrylate and benzyl (meth)acrylate are further more preferable.

The water-insoluble polymer, which forms the particles of the self-dispersible polymer, includes preferably structure units derived from an aromatic group-containing (meth)acrylate monomer (preferably, structural units derived from phenoxyethyl (meth)acrylate and/or structural units derived from benzyl (meth)acrylate) in a copolymerization ratio of 15 to 80% by mass, based on the total mass amount of the self-dispersible polymer particles, in terms of the control of the hydrophilicity and the hydrophobicity of the polymer.

The water-insoluble polymer includes preferably structural units derived from an aromatic group-containing (meth)acrylate monomer in a copolymerization ratio of 15 to 80% by mass, structure units derived from a carboxyl group-containing monomer, and structural units derived from an alkyl group-containing monomer (preferably structural units derived from an alkyl ester of (meth)acrylic acid), in terms of the control of hydrophilicity and hydrophobicity of the polymer; and more preferably includes structural units derived from phenoxyethyl (meth)acrylate and/or structural units derived from benzyl (meth)acrylate in a copolymerization ratio of 15 to 80% by mass, structural units derived from a carboxyl group-containing monomer, and structural units derived from an alkyl group-containing monomer (preferably structural units derived from a C₁₋₄ alkyl ester of (meth)acrylic acid). It is more preferable that the polymer has an acid value of 25 to 95 and a weight average molecular weight of 5000 to 150000, in addition to the above-mentioned conditions.

Specific examples of the water-insoluble polymer, which forms the self-dispersible polymer particles, may include phenoxyethyl acrylate/methyl methacrylate/acrylic acid copolymers (50/45/5), phenoxyethyl acrylate/benzyl methacrylate/isobutyl methacrylate/methacrylic acid copolymers (30/35/29/6), phenoxyethyl methacrylate/isobutyl methacrylate/methacrylic acid copolymers (50/44/6), phenoxyethyl acrylate/methyl methacrylate/ethyl acrylate/acrylic acid copolymers (30/55/10/5), benzyl methacrylate/isobutyl methacrylate/methacrylic acid copolymers (35/59/6), styrene/phenoxyethyl acrylate/methyl methacrylate/acrylic acid copolymers (10/50/35/5), benzyl acrylate/methyl methacrylate/acrylic acid copolymers (55/40/5), phenoxyethyl methacrylate/benzyl acrylate/methacrylic acid copolymers (45/47/8), styrene/phenoxyethyl acrylate/butyl methacrylate/acrylic acid copolymers (5/48/40/7), benzyl methacrylate/isobutyl methacrylate/cyclohexyl methacrylate/methacrylic acid copolymers (35/30/30/5), phenoxyethyl acrylate/methyl methacrylate/butyl acrylate/methacrylic acid copolymers (12/50/30/8), benzyl acrylate/isobutyl methacrylate/acrylic acid copolymers (93/2/5), styrene/phenoxyethyl methacrylate/butyl acrylate/acrylic acid copolymers (50/5/20/25), styrene/butyl acrylate/acrylic acid copolymers (62/35/3), methyl methacrylate/phenoxyethyl acrylate/acrylic acid copolymers (45/51/4), methyl methacrylate/phenoxyethyl acrylate/acrylic acid copolymers (45/49/6), methyl methacrylate/phenoxyethyl acrylate/acrylic acid copolymers (45/48/7), methyl methacrylate/phenoxyethyl acrylate/acrylic acid copolymers (45/47/8), methyl methacrylate/phenoxyethyl acrylate/acrylic acid copolymers (45/45/10), and the like. In the above examples, the numbers in the parentheses show mass ratios of copolymerization components.

<Other Components>

The curable ink composition in the present embodiment may be formed by using other additives in addition to the components described above. Examples of the other additive may include known additives such as a polymerization inhibitor, an agent of preventing drying (a wetting agent), an agent of preventing decoloration, an emulsion stabilizer, a penetration enhancer, an ultraviolet absorber, a preservative, an anti-mold agent, a pH-controlling agent, a regulator of surface tension, an anti-foaming agent, a viscosity modifier, a dispersion stabilizer, a rust inhibitor and a chelating agent.

### MODIFICATION EXAMPLE

The particular embodiments of the invention have been explained in detail, but the invention is not limited to the embodiments, and it is apparent for those skilled in the art that other various embodiments can be performed within the range of the invention. For example, the plural embodiments described above may be performed by arbitrarily combining them. In addition, the following modification examples may be arbitrarily combined.

In the embodiments described above, for example, the paper sheet P is listed as one example of the recording medium, but the invention can be applied to a recording medium such as yarn, fiber, cloth, leather, metal, plastic, glass, wood, ceramic, or an OHP film.

In the embodiments described above, the inkjet recording apparatus 10 provided with the plural inkjet heads 56M, 56K, 56C and 56Y has been explained, but an inkjet recording apparatus 10 provided with a single inkjet head from which plural kinds of aqueous UV inks are jetted may be used.

The case in which ultraviolet rays are irradiated to the curable ink composition has been explained, but light having another wavelength region such as infrared light may be irradiated. In this case, as the curable ink composition, a photocurable ink composition is used which includes a material that is cured by the light having another wavelength region such as the infrared light. As the photocurable ink composition, a composition that can be cured by heat rather than light may be used.

In the embodiment described above, the configuration with the standard colors (four colors) of MKYC has been explained, but the kinds and number of the color inks are not limited to the present embodiment, and pale inks, deep inks, and specific color inks may be added if necessary. For example, a configuration can be used in which an inkjet head which jets a light ink such as light cyan or light magenta is added.

According to the invention, there are provided the following embodiments <1> to <14>.

<1> An Image Forming Apparatus Comprising:

a jetting head that jets, onto a recording medium, a curable ink composition including 3% by mass to 18% by mass, based on a total amount of the ink composition, of a polyfunctional polymerizable compound, and water;

a chain gripper that grips a leading end of the recording medium onto which the curable ink composition has been jetted from the jetting head, and conveys the recording medium; and

an irradiation device that irradiates light to the recording medium which is conveyed by the chain gripper and onto which the curable ink composition has been jetted.

<2> The image forming apparatus according to <1>, wherein the curable ink composition includes 15% by mass or less, based on the total amount of the ink composition, of the polymerizable compound.

<3> The image forming apparatus according to <1> or <2>, further comprising a suction plate that sucks a back surface of the recording medium which is conveyed by the chain gripper.

<4> The image forming apparatus according to <3>, wherein the curable ink composition includes 5% by mass or more, based on the total amount of the ink composition, of the polymerizable compound.

<5> The image forming apparatus according to any one of <1> to <4>, wherein the polyfunctional polymerizable compound is a polyfunctional (meth)acrylamide compound represented by the following formula (1):

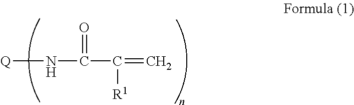

wherein Q represents an n valent linking group; R¹ represents a hydrogen atom or a methyl group; and n represents an integer of 2 or more.

<6> The image forming apparatus according to <4>, wherein the polyfunctional polymerizable compound is a trifunctional, tetrafunctional or pentafunctional (meth)acrylamide compound.

<7> The image forming apparatus according to <6>, wherein the polyfunctional polymerizable compound is a trifunctional or tetrafunctional (meth)acrylamide compound.

<8> The image forming apparatus according to <3> or <4>, further comprising a mechanism that controls a temperature of the suction plate.

<9> An image forming method comprising:

jetting, onto a recording medium, a curable ink composition including 3% by mass to 18% by mass, based on a total amount of the ink composition, of a polyfunctional polymerizable compound, and water;

gripping a leading end of the recording medium onto which the curable ink composition has been jetted, and conveying the recording medium; and

irradiating light to the recording medium, onto which the curable ink composition has been jetted, during the conveyance of the recording medium.

<10> The image forming method according to <9>, wherein the curable ink composition includes 15% by mass or less, based on the total amount of the ink composition, of the polymerizable compound.

<11> The image forming method according to <9> or <10>, wherein the curable ink composition includes 5% by mass or more, based on the total amount of the ink composition, of the polymerizable compound.

<12> The image forming method according to any one of <9> to <11>, wherein the polyfunctional polymerizable compound is a polyfunctional (meth)acrylamide compound represented by the following formula (1):

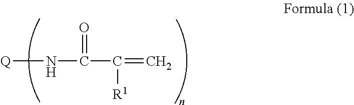

wherein Q represents an n valent linking group; R¹ represents a hydrogen atom or a methyl group; and n represents an integer of 2 or more.

<13> The image forming method according to <11>, wherein the polyfunctional polymerizable compound is a trifunctional, tetrafunctional or pentafunctional (meth)acrylamide compound.

<14> The image forming method according to <13>, wherein the polyfunctional polymerizable compound is a trifunctional or tetrafunctional (meth)acrylamide compound.

According to the invention, the inhibition of the image damage and the stain on the conveyance surface during the duplex printing, and the inhibition of the paper sheet deformation during the printing are both achieved.

### EXAMPLES

Examples are explained below, but the invention is not limited to these Examples. The unit “parts” is on a mass basis, unless otherwise stated.

—Production of Curable Ink Composition—

A curable ink composition of an aqueous UV ink was produced as follows.

<Preparation of Polymer Dispersant 1 Solution>

To a reaction vessel were added 6 parts of styrene, 11 parts of stearyl methacrylate, 4 parts of a styrene macromer AS-6 (manufactured by Toagosei Co., Ltd.), 5 parts of BLENMER PP-500 (manufactured by NOF Corporation), 5 parts of methacrylic acid, 0.05 parts of 2-mercaptoethanol, and 24 parts of methyl ethyl ketone to prepare a mixed solution. Separately, to a dropping funnel were added 14 parts of styrene, 24 parts of stearyl methacrylate, 9 parts of styrene macromer AS-6 (manufactured by Toagosei Co., Ltd.), 9 parts of BLENMER PP-500 (manufactured by NOF Corporation), 10 parts of methacrylic acid, 0.13 parts of 2-mercaptoethanol, 56 parts of methyl ethyl ketone, and 1.2 parts of 2,2′-azobis(2,4-dimethylvaleronitrile) to prepare a mixed solution.

After that, the temperature of the mixed solution in the reaction vessel was elevated to 75° C. under a nitrogen atmosphere while the mixture was stirred, to which the mixed solution in the dropping funnel was gradually added dropwise over one hour. After two hours from the completion of the addition, a solution in which 1.2 parts of 2,2′-azobis(2,4-dimethylvaleronitrile) was dissolved in 12 parts of methyl ethyl ketone was added dropwise thereto over three hours, and the mixture was aged at 75° C. for two hours and at 80° C. for two hours, thereby obtaining a polymer dispersant 1 solution.

The solvent was removed from a part of the obtained polymer dispersant 1 solution to perform isolation. The obtained solid component is diluted with tetrahydrofuran to adjust a concentration to 0.1% by mass, and a weight average molecular weight thereof was measured using a high performance GPC (gel permeation chromatography) HLC-8220 GPC (manufactured by Tosoh Corporation) in which three columns of TSKgeL SuperHZM-H, TSKgeL SuperHZ4000 and TSKgeL SuperHZ2000 (manufactured by Tosoh Corporation) were connected in series. The weight average molecular weight measured was 25,000 in terms of polystyrene. An acid value, which was obtained in accordance with a method described in JIS (JIS K0070: 1992), was 99 mgKOH/g.

<Preparation of Pigment Dispersion Liquid K>

In a vessel were put 5.0 g, in terms of a solid content, of the obtained polymer dispersant 1 solution, 10.0 g of carbon black (MB-100 manufactured by Mitsubishi Chemical Corporation), 40.0 g of methyl ethyl ketone, 8.0 g of 1 mol/L (liter; hereinafter the same) sodium hydroxide, and 82.0 g of deionized water, together with 300 g of 0.1 mm zirconia beads, and the mixture was dispersed at 1000 rpm for 6 hours using a ready mill disperser (manufactured by IMEX Co., Ltd). The obtained dispersion liquid was concentrated under reduced pressure using an evaporator until the methyl ethyl ketone was sufficiently distilled away, and the resulting product was concentrated until the pigment concentration reached 10% by mass, thereby preparing a pigment dispersion liquid K in which the water-dispersible pigment was dispersed.

The volume average particle size (secondary particles) of the obtained pigment dispersion liquid K was measured in accordance with a dynamic light scattering method using a Micorotrac particle size distribution measuring device (trade name: Version 10.1.2-211BH, manufactured by NIKKISO Co., Ltd.), and it was 80 nm.

<Synthesis of Polyfunctional (Meth)acrylamide B-1>

—First Step—

To a 1 L three-neck flask provided with a stirrer bar were added 121 g (one equivalent) of tris(hydroxymethyl)aminomethane (manufactured by Tokyo Chemical Industry Co., Ltd.), 84 ml of a 50% by mass aqueous potassium hydroxide solution, and 423 ml of toluene, and the mixture was stirred. The reaction system was maintained at a temperature of 20 to 25° C. in a water bath, and 397.5 g (7.5 equivalents) of acrylonitrile was added dropwise to the system over two hours. After the addition, the mixture was stirred for 1.5 hours. After that, 540 ml of toluene was added to the reaction system, the reaction mixture was transferred to a separating funnel, and an aqueous layer was removed. After the remaining organic layer was dried on magnesium sulfate, a filtration thereof was performed through celite, and solvent was distilled away under reduced pressure to obtain an acrylonitrile adduct. The ¹H-NMR and MS analysis results of the obtained substance sufficiently agreed with the known product, and thus the obtained adduct was used in the subsequent reduction reaction without further purification.

—Second Step—

In a 1 L autoclave were put 24 g of the obtained acrylonitrile adduct, 48 g of a Ni catalyst (Raney nickel 2400 manufactured by W. R. Grace & Co.) and 600 ml of a 25% by mass aqueous ammonia solution (water:methanol=1:1), the mixture was suspended, and the reaction vessel was sealed. To the reaction vessel was introduced 10 MPa hydrogen, and the suspension was reacted at a reaction temperature of 25° C. for 16 hours.

The disappearance of the starting materials was confirmed by ¹H-NMR, the reaction mixture was filtered through celite, and the celite was washed with methanol several times. The solvent was distilled away from the filtrate under reduced pressure to obtain a polyamine compound. The obtained substance was used in the subsequent reaction without further purification.

—Third Step—

To a 2 L three-neck flask provided with a stirrer were added 30 g of the obtained polyamine compound, 120 g (14 equivalents) of NaHCO₃, 1 L of dichloromethane, and 50 ml of water, and 92.8 g (10 equivalents) of acrylic acid chloride was added dropwise thereto in an ice bath over three hours. After that, the mixture was stirred at room temperature for three hours. After the disappearance of the starting materials was confirmed by ¹H-NMR, the solvent was distilled away from the reaction mixture under reduced pressure. Subsequently, the reaction mixture was dried on magnesium sulfate, the celite filtration was performed, and the solvent was distilled away under reduced pressure. Finally, the resulting product was purified through a column chromatography (methyl acetate/methanol=4:1) to obtain a solid of polyfunctional (meth)acrylamide B-1 having a structure described above at an ordinary temperature. The polyfunctional (meth)acrylamide B-1, which was obtained through the three steps described above, had a yield of 40% by mass.

<Synthesis of Polymerizable Monomers (B-2) to (B-5)>

The polyfunctional (meth)acrylamides B-2 to B-5 having structures described above were synthesized according to the synthesis procedures of the polyfunctional (meth)acrylamide B-1 described above.

<Preparation of Self-Dispersible Polymer Particles>

In a 2 L three-neck flask provided with a stirrer, a thermometer, a reflux condenser, and a nitrogen gas-introducing tube was put 360.0 g of methyl ethyl ketone, and the temperature was elevated to 75° C. After that, a mixed solution including 180.0 g of phenoxyethyl acrylate, 162.0 g of methyl methacrylate, 18.0 g of acrylic acid, 72 g of methyl ethyl ketone, and 1.44 g of “V-601” (manufactured by Wako Pure Chemical Industries, Ltd.) was added dropwise at a constant speed so that the addition was completed in two hours, while the temperature in the flask was kept at 75° C. After the addition was completed, a solution including 0.72 g of “V-601” and 36.0 g of methyl ethyl ketone was added to the resulting product, and the mixture was stirred at 75° C. for two hours. Then a solution including 0.72 g of “V-601” and 36.0 g of isopropanol was added to the resulting product, and the mixture was stirred at 75° C. for two hours. After that, the temperature was elevated to 85° C., and the stirring was continued for further two hours to obtain a resin solution of a phenoxyethyl acrylate/methyl methacrylate/acrylic acid(=50/45/5 [a mass ratio]) copolymer.

The obtained copolymer had a weight average molecular weight (Mw), measured in the same manner as in the case of the polymer dispersant 1 described above, of 64,000 (in accordance with a gel permeation chromatography (GPC) and calculated in terms of polystyrene), and an acid value of 38.9 mgKOH/g.

Next, 668.3 g of the obtained resin solution was weighed, 388.3 g of isopropanol and 145.7 ml of a 1 mol/L aqueous NaOH solution were added to the resin solution, and the temperature in the reaction vessel was elevated to 80° C. Then, 720.1 g of distilled water was added dropwise thereto at a rate of 20 ml/min, and water-dispersing was performed. After that, the temperature in the reaction vessel was kept at 80° C. for two hours, at 85° C. for two hours, and at 90° C. for two hours in atmospheric pressure. The pressure inside the reaction vessel was reduced to distill away 913.7 g, in the total amount, of isopropanol, methyl ethyl ketone and distilled water, thereby obtaining an aqueous dispersion P-1 of self-dispersible polymer particles, having a solid concentration of 28.0% by mass.

<Preparation of Curable Ink Composition>

After mixing components shown in table 1 described below, the mixture was passed through a membrane filter (a pore size: 5 μm) to remove coarse particles, thereby preparing curable ink compositions according to Examples 1 to 25 and Comparative Examples 1 to 11. In Table, the unit of the number is % by mass. The curable ink compositions according to Examples 1 to 25 included the polyfunctional polymerizable compound in an amount of 3% by mass to 18% by mass, and the curable ink composition according to Comparative Examples 1 to 11 included the polyfunctional polymerizable compound in an amount of less 3% by mass or more than 18% by mass.

TABLE 1

| | Pigment | | | | | | | | | | | | |
|---|---|---|---|---|---|---|---|---|---|---|---|---|---|
| | dispersion | | | | | | | | | | | | |
| | liquid | | | | | | | | Self- | | | | |
| | (pigment | Monofunctional | | | | | | | dispersible | | | | |
| | solid | polymerizable | Polyfunctional | | | | | Initiator | polymer P-1 | | | | |
| | content) | monomer | polymerizable monomer | | | | | Irgacure | (solid | Surfactant | | Deionized | |
| | K | A-1 | B-1 | B-2 | B-3 | B-4 | B-5 | 2959 | content) | E 1010 | Glycerin | water | Total |
| Comparative | 3 | 20 | | | | | | 3 | 1 | 1 | 5 | the | 100 |
| Example 1 | | | | | | | | | | | | remainder | |
| Comparative | 3 | 19 | 1 | | | | | 3 | 1 | 1 | 5 | the | 100 |
| Example 2 | | | | | | | | | | | | remainder | |
| Comparative | 3 | 19 | | 1 | | | | 3 | 1 | 1 | 5 | the | 100 |
| Example 3 | | | | | | | | | | | | remainder | |
| Comparative | 3 | 19 | | | 1 | | | 3 | 1 | 1 | 5 | the | 100 |
| Example 4 | | | | | | | | | | | | remainder | |
| Comparative | 3 | 19 | | | | 1 | | 3 | 1 | 1 | 5 | the | 100 |
| Example 5 | | | | | | | | | | | | remainder | |
| Comparative | 3 | 19 | | | | | 1 | 3 | 1 | 1 | 5 | the | 100 |
| Example 6 | | | | | | | | | | | | remainder | |
| Example 1 | 3 | 17 | 3 | | | | | 3 | 1 | 1 | 5 | the | 100 |
| | | | | | | | | | | | | remainder | |
| Example 2 | 3 | 17 | | 3 | | | | 3 | 1 | 1 | 5 | the | 100 |
| | | | | | | | | | | | | remainder | |
| Example 3 | 3 | 17 | | | 3 | | | 3 | 1 | 1 | 5 | the | 100 |
| | | | | | | | | | | | | remainder | |
| Example 4 | 3 | 17 | | | | 3 | | 3 | 1 | 1 | 5 | the | 100 |
| | | | | | | | | | | | | remainder | |
| Example 5 | 3 | 17 | | | | | 3 | 3 | 1 | 1 | 5 | the | 100 |
| | | | | | | | | | | | | remainder | |
| Example 6 | 3 | 15 | 5 | | | | | 3 | 1 | 1 | 5 | the | 100 |
| | | | | | | | | | | | | remainder | |
| Example 7 | 3 | 15 | | 5 | | | | 3 | 1 | 1 | 5 | the | 100 |
| | | | | | | | | | | | | remainder | |
| Example 8 | 3 | 15 | | | 5 | | | 3 | 1 | 1 | 5 | the | 100 |
| | | | | | | | | | | | | remainder | |
| Example 9 | 3 | 15 | | | | 5 | | 3 | 1 | 1 | 5 | the | 100 |
| | | | | | | | | | | | | remainder | |
| Example 10 | 3 | 15 | | | | | 5 | 3 | 1 | 1 | 5 | the | 100 |
| | | | | | | | | | | | | remainder | |
| Example 11 | 3 | 10 | 10 | | | | | 3 | 1 | 1 | 5 | the | 100 |
| | | | | | | | | | | | | remainder | |
| Example 12 | 3 | 10 | | 10 | | | | 3 | 1 | 1 | 5 | the | 100 |
| | | | | | | | | | | | | remainder | |
| Example 13 | 3 | 10 | | | 10 | | | 3 | 1 | 1 | 5 | the | 100 |
| | | | | | | | | | | | | remainder | |
| Example 14 | 3 | 10 | | | | 10 | | 3 | 1 | 1 | 5 | the | 100 |
| | | | | | | | | | | | | remainder | |
| Example 15 | 3 | 10 | | | | | 10 | 3 | 1 | 1 | 5 | the | 100 |
| | | | | | | | | | | | | remainder | |
| Example 16 | 3 | 5 | 15 | | | | | 3 | 1 | 1 | 5 | the | 100 |
| | | | | | | | | | | | | remainder | |
| Example 17 | 3 | 5 | | 15 | | | | 3 | 1 | 1 | 5 | the | 100 |
| | | | | | | | | | | | | remainder | |
| Example 18 | 3 | 5 | | | 15 | | | 3 | 1 | 1 | 5 | the | 100 |
| | | | | | | | | | | | | remainder | |
| Example 19 | 3 | 5 | | | | 15 | | 3 | 1 | 1 | 5 | the | 100 |
| | | | | | | | | | | | | remainder | |
| Example 20 | 3 | 5 | | | | | 15 | 3 | 1 | 1 | 5 | the | 100 |
| | | | | | | | | | | | | remainder | |
| Example 21 | 3 | 2 | 18 | | | | | 3 | 1 | 1 | 5 | the | 100 |
| | | | | | | | | | | | | remainder | |
| Example 22 | 3 | 2 | | 18 | | | | 3 | 1 | 1 | 5 | the | 100 |
| | | | | | | | | | | | | remainder | |
| Example 23 | 3 | 2 | | | 18 | | | 3 | 1 | 1 | 5 | the | 100 |
| | | | | | | | | | | | | remainder | |
| Example 24 | 3 | 2 | | | | 18 | | 3 | 1 | 1 | 5 | the | 100 |
| | | | | | | | | | | | | remainder | |
| Example 25 | 3 | 2 | | | | | 18 | 3 | 1 | 1 | 5 | the | 100 |
| | | | | | | | | | | | | remainder | |
| Comparative | 3 | 0 | 20 | | | | | 3 | 1 | 1 | 5 | the | 100 |
| Example 7 | | | | | | | | | | | | remainder | |
| Comparative | 3 | 0 | | 20 | | | | 3 | 1 | 1 | 5 | the | 100 |
| Example 8 | | | | | | | | | | | | remainder | |
| Comparative | 3 | 0 | | | 20 | | | 3 | 1 | 1 | 5 | the | 100 |
| Example 9 | | | | | | | | | | | | remainder | |
| Comparative | 3 | 0 | | | | 20 | | 3 | 1 | 1 | 5 | the | 100 |
| Example 10 | | | | | | | | | | | | remainder | |
| Comparative | 3 | 0 | | | | | 20 | 3 | 1 | 1 | 5 | the | 100 |
| Example 11 | | | | | | | | | | | | remainder | |

Details of the components in Table 1 described above are as follows:

Monofunctional polymerizable monomer A-1: hydroxyethyl acrylamide (Kohjin Co., Ltd.)

Polymerization initiator: IRGACURE 2959 (BASF Japan Ltd.; 1-[4-(2-hydroxyethoxy)-phenyl]-2-hydroxy-2-methyl-1-propan-1-one)

Surfactant: OLFINE E 1010 (Nissin Chemical Co., Ltd.)

<Preparation of Process Liquid 1>

Components shown in Composition described below were mixed to prepare process liquid 1. The pH of the process liquid 1 (25° C.) was set at 1.02. The pH was measured using a pH meter WM-50EG, manufactured by DKK-TOA Corporation, while the temperature was adjusted to 25° C.

<Composition>

malonic acid (manufactured by Wako Pure Chemical Industries, Ltd.)
25% by mass

diethyleneglycol monomethyl ether (manufactured by Wako Pure Chemical Industries, Ltd.)
20% by mass

EMULGEN P109 (a nonionic surfactant manufactured by Kao Corporation)
1% by mass

deionized water the remainder in the total of 100% by mass

—Evaluation of Curable Ink Composition—

Using an inkjet recording apparatus shown in FIG. 1, duplex printing was performed, while back tension was applied to a paper sheet P conveyed by the chain gripper, or the back tension was not applied thereto, and a degree of stain on the conveyance surface, a degree of stain on the application roller/the paper sheet holding roller, an occurrence level of scratch on the back surface (image damage), and a curing shrinkage curling amount were evaluated. Hereinafter, the expression “a case in which the back tension is applied to the paper sheet P conveyed by the chain gripper” is abbreviated as the expression “a case in which the back surface of the paper sheet P was sucked.”

Specifically, an image was formed under conditions shown below.

Paper sheet: A medium octavo size of i-BEST W (Nippon Daishowa Paperboard Co., Ltd., a paper weight: 310 g/m²)
Linear velocity: 535 mm/second
Image: Solid image, an average in-plane amount of ink applied: 4.0 pL
Curing condition: A metal halide lamp, manufactured by Eye Graphics Co., Ltd., 140 W/cm (illuminance: 3.0 W/cm², integral exposure amount: 0.75 J/cm²)

<Degree of Stain on Conveyance Surface>

A chain delivery conveyance surface (guide plate) was cleaned before performing printing, 100 paper sheets were subjected to duplex printing under the conditions described above. After that, the conveyance surface was wiped with water using a Kimwipe impregnated with an adequate amount of water. The conveyance surface was wiped along the paper sheet-conveying direction, and the full width of the conveyance surface was wiped by repeatedly using the same Kimwipe. The degree of the stain on the conveyance surface was evaluated by a degree of ink transferred to the Kimwipe at that time.

Criteria of the degree of stain on the conveyance surface are shown below. The evaluation results A to C are within the acceptable range.

“A”: Transfer of ink stain to the Kimwipe is not observed.
“B”: Transfer of ink stain to the Kimwipe is observed on less than 5% of the wiping surface.
“C”: Transfer of ink stain to the Kimwipe is observed on from 5% to less than 10% of the wiping surface.
“D”: Transfer of ink stain to the Kimwipe is observed on 10% or more of the wiping surface.

<Degree of Stain on Application Roller/Paper Sheet Holding Roller>

Similarly, the roller surface was cleaned before printing, and 100 paper sheets were subjected to duplex printing under the conditions described above. After that, the surface of the roller was wiped with water using a Kimwipe impregnated with an adequate amount of water. The degree of the stain on the application roller/the paper sheet holding roller was evaluated by a degree of ink transferred to the Kimwipe.

Criteria of the degree of stain on the application roller/the paper sheet holding roller are shown below. The evaluation results A to C are within the acceptable range.

“A”: Transfer of ink stain to the Kimwipe is not observed.
“B”: Transfer of ink stain to the Kimwipe is observed on less than 5% of the wiping surface.
“C”: Transfer of ink stain to the Kimwipe is observed on from 5% to less than 10% of the wiping surface.
“D”: Transfer of ink stain to the Kimwipe is observed on 10% or more of the wiping surface.

<Occurrence Level of Scratch on Back Surface>

Next, scratches on the printed surface of the paper sheet which had been subjected to the duplex printing (scratches on the bake surface) were evaluated.

Criteria of the scratches on the back surface are shown below. The evaluation results A to C are within the acceptable range.

“A”: No scratches were visually observed.
“B”: One scratch, which did not expose the paper surface, was visually observed.
“C”: One scratch, which exposed the paper surface, was visually observed, or two or more scratches, which did not expose the paper surface, were visually observed.
“D”: Two or more scratches, which exposed the paper surface, were visually observed.

<Curing Shrinkage Curling Amount>

Next, curling amounts (lifting amount from a flatbed) of four corners of the paper sheet subjected to simplex printing were measured. The curing shrinkage curling amount was evaluated by the average value thereof.

Criteria of the curing shrinkage curling amount are described below. The evaluation results A to C are within the acceptable range.

“A”: less than 15 mm
“B”: From 15 mm to less than 20 mm
“C”: From 20 mm to less than 30 mm
“D”: From 30 mm to less than 40 mm

The evaluation results of the curable ink compositions according to Examples 1 to 25 and Comparative Examples 1 to 11 are summarized in table 2.

TABLE 2

| | Polyfunctional | | | | | | | | Back surface suction | |
|---|---|---|---|---|---|---|---|---|---|---|
| | polymerizable monomer | | | | | | No back surface suction | | performed | |
| | | Number of | | | Stain on roller | | Stain on | | Stain on | |
| | | functional | % by | Shrinkage | Pre-coating | Paper sheet | conveyance | Scratch on | conveyance | Scratch on |
| | Kind | groups | mass | curling | roller | holding roller | surface | back surface | surface | back surface |
| Comparative | — | — | 0 | A | C | C | C | C | D | D |
| Example 1 | | | | | | | | | | |
| Comparative | B-1 | 4 | 1 | A | C | C | C | C | D | D |
| Example 2 | | | | | | | | | | |
| Comparative | B-2 | 3 | 1 | A | C | C | C | C | D | D |
| Example 3 | | | | | | | | | | |
| Comparative | B-3 | 4 | 1 | A | C | C | C | C | D | D |
| Example 4 | | | | | | | | | | |
| Comparative | B-4 | 5 | 1 | A | C | C | C | C | D | D |
| Example 5 | | | | | | | | | | |
| Comparative | B-5 | 2 | 1 | A | C | C | C | C | D | D |
| Example 6 | | | | | | | | | | |
| Example 1 | B-1 | 4 | 3 | A | A | A | A | A | B | B |
| Example 2 | B-2 | 3 | 3 | A | A | A | A | A | B | B |
| Example 3 | B-3 | 4 | 3 | A | A | A | A | A | B | B |
| Example 4 | B-4 | 5 | 3 | A | A | A | A | A | C | C |
| Example 5 | B-5 | 2 | 3 | A | A | A | A | A | C | C |
| Example 6 | B-1 | 4 | 5 | A | A | A | A | A | A | A |
| Example 7 | B-2 | 3 | 5 | A | A | A | A | A | A | A |
| Example 8 | B-3 | 4 | 5 | A | A | A | A | A | A | A |
| Example 9 | B-4 | 5 | 5 | A | A | A | A | A | A | B |
| Example 10 | B-5 | 2 | 5 | A | A | A | A | A | A | B |
| Example 11 | B-1 | 4 | 10 | A | A | A | A | A | A | A |
| Example 12 | B-2 | 3 | 10 | A | A | A | A | A | A | A |
| Example 13 | B-3 | 4 | 10 | A | A | A | A | A | A | A |
| Example 14 | B-4 | 5 | 10 | A | A | A | A | A | A | A |
| Example 15 | B-5 | 2 | 10 | A | A | A | A | A | A | B |
| Example 16 | B-1 | 4 | 15 | A | A | A | A | A | A | A |
| Example 17 | B-2 | 3 | 15 | A | A | A | A | A | A | A |
| Example 18 | B-3 | 4 | 15 | A | A | A | A | A | A | A |
| Example 19 | B-4 | 5 | 15 | A | A | A | A | A | A | A |
| Example 20 | B-5 | 2 | 15 | A | A | A | A | A | A | A |
| Example 21 | B-1 | 4 | 18 | B | A | A | A | A | A | A |
| Example 22 | B-2 | 3 | 18 | B | A | A | A | A | A | A |
| Example 23 | B-3 | 4 | 18 | B | A | A | A | A | A | A |
| Example 24 | B-4 | 5 | 18 | B | A | A | A | A | A | A |
| Example 25 | B-5 | 2 | 18 | B | A | A | A | A | A | A |
| Comparative | B-1 | 4 | 20 | D | A | A | A | A | A | A |
| Example 7 | | | | | | | | | | |
| Comparative | B-2 | 3 | 20 | D | A | A | A | A | A | A |
| Example 8 | | | | | | | | | | |
| Comparative | B-3 | 4 | 20 | D | A | A | A | A | A | A |
| Example 9 | | | | | | | | | | |
| Comparative | B-4 | 5 | 20 | D | A | A | A | A | A | A |
| Example 10 | | | | | | | | | | |
| Comparative | B-5 | 2 | 20 | D | A | A | A | A | A | A |
| Example 11 | | | | | | | | | | |

As shown in Table 2, in a case in which the back surface of the paper sheet was sucked, all of the curable ink compositions according to Comparative Examples 1 to 6, which included less than 3% by mass of the polyfunctional polymerizable compound, had the evaluation “D” in the scratch on the back surface and the degree of the stain on the conveyance surface. In a case in which the back surface suction was not performed, all of the curable ink compositions according to Comparative Examples 1 to 6 had the evaluation “C” in the scratch on the back surface and the degree of the stain on the conveyance surface.

On the other hand, in a case in which the back surface of the paper sheet was sucked, all of the curable ink compositions according to Examples 1 to 25, which included 3% by mass or more of the polyfunctional polymerizable compound, had good results, i.e. there was no evaluation “D” in the scratch on the back surface and the degree of the stain on the conveyance surface. In a case in which the back surface suction was not performed, all of the curable ink compositions according to Examples 1 to 25 had the evaluation “A” in the scratch on the back surface and the degree of the stain on the conveyance surface.

All of the curable ink compositions according to Examples 1 to 25, therefore, had better evaluation results in the scratch on the back surface and the degree of the stain on the conveyance surface than the curable ink compositions according to Comparative Examples 1 to 6, and it can be said that they can inhibit the scratch on the back surface and the stain on the conveyance surface.

In particular, in a case in which the back surface of the paper sheet was sucked, the curable ink compositions according to Examples 1 to 3, which included the trifunctional or tetrafunctional polymerizable compound, had two stage better evaluation results in the scratch on the back surface and the degree of the stain on the conveyance surface than those of the curable ink compositions according to Comparative Examples 1 to 6, that is, the evaluation results were “B” in the former, whereas “D” in the latter. It can be said that the former could more inhibit the scratch on the back surface and the stain on the conveyance surface.

All of the curable ink compositions according to Examples 1 to 25 had better evaluations in the degree of the stain on the application roller/the paper sheet holding roller, compared to the curable ink compositions according to Comparative Examples 1 to 6, that is, the evaluation results were “A” in the former, whereas “C” in the latter. It can be said that the former could inhibit the stain on the application roller/the paper sheet holding roller.

The curable ink compositions according to Comparative Examples 7 to 11, which included more than 18% by mass of the polyfunctional polymerizable compound, had the evaluation “D” in the curing shrinkage curling which occurred when the ink was cured by the UV irradiation.

On the other hand, the curable ink compositions according to Examples 1 to 25, which included 18% by mass of less of the polyfunctional polymerizable compound, had good results, that is, there was no evaluation “D” in the curing shrinkage curling which occurred when the ink was cured by the UV irradiation.

All of the curable ink compositions according to Examples 1 to 25, therefore, had better evaluation results in the curing shrinkage curling than those of the curable ink compositions according to Comparative Examples 7 to 11, and it can be said that they could inhibit the paper sheet deformation during the printing.

The curable ink compositions according to Examples 1 to 20, which included 15% by mass or less of the polyfunctional polymerizable compound, had better evaluation than that of the curable ink compositions according to Examples 21 to 25, that is, the evaluation in the curing shrinkage curling was “A” in the former, whereas “B” in the latter, and it can be said that the former could more inhibit the paper sheet deformation.

In a case in which the back surface of the paper sheet was sucked, the curable ink compositions according to Examples 6 to 25, which included 5% by mass or more of the polyfunctional polymerizable compound, had the better evaluation results in the scratch on the back surface and the degree of the stain on the conveyance surface than those of the curable ink compositions according to Examples 1 to 5, that is, the evaluation results were “A” or “B” in the former, whereas “B” or “C” in the latter, and it can be said the former could more inhibit the scratch on the back surface and the stain on the conveyance surface.

In a case in which the back surface of the paper sheet was sucked, some of the curable ink compositions according to Examples 11 to 25, which included 10% by mass or more of the polyfunctional polymerizable compound, had better evaluation results in the scratch on the back surface than those of the curable ink compositions according to Examples 6 to 10, that is, the evaluation results were “A” in the former, whereas “B” in the latter, and it can be said that the former could still more inhibit the scratch on the back surface.

In a case in which the back surface of the paper sheet was sucked, the curable ink compositions according to Examples 16 to 25, which included 15% by mass or more of the polyfunctional polymerizable compound, had better evaluation results in the scratch on the back surface than those of the curable ink compositions according to Examples 11 to 15, that is, all of the evaluation results were “A” in the former, and it can be said that they could eliminate the scratch on the back surface.

In the curable ink compositions including the trifunctional, tetrafunctional or pentafunctional (meth)acrylamide compound, when the compositions included 10% by mass or more of the acrylamide compound, the evaluation results in the scratch on the back surface were all “A,” and it can be said that they could eliminate the scratch on the back surface.

Furthermore, in the curable ink compositions including the trifunctional or tetrafunctional (meth)acrylamide compound, when the compositions included 5% by mass or more of the acrylamide compound, the evaluation results in the scratch on the back surface were all “A,” and it can be said that they could eliminate the scratch on the back surface.

All publications, patent applications, and technical standards mentioned in this specification are herein incorporated by reference to the same extent as if each individual publication, patent application, or technical standard was specifically and individually indicated to be incorporated by reference.

What is claimed is:

1. An image forming apparatus comprising:
a jetting head that jets, onto a recording medium, a curable ink composition including 3% by mass to 18% by mass, based on a total amount of the ink composition, of a polyfunctional polymerizable compound, and water;
a chain gripper that grips a leading end of the recording medium onto which the curable ink composition has been jetted from the jetting head, and conveys the recording medium; and
an irradiation device that irradiates light to the recording medium which is conveyed by the chain gripper and onto which the curable ink composition has been jetted.

2. The image forming apparatus according to claim 1, wherein the curable ink composition includes 15% by mass or less, based on the total amount of the ink composition, of the polymerizable compound.

3. The image forming apparatus according to claim 1, further comprising a suction plate that sucks a back surface of the recording medium which is conveyed by the chain gripper.

4. The image forming apparatus according to claim 3, wherein the curable ink composition includes 5% by mass or more, based on the total amount of the ink composition, of the polymerizable compound.

5. The image forming apparatus according to claim 1, wherein the polyfunctional polymerizable compound is a polyfunctional (meth)acrylamide compound represented by the following formula (1): 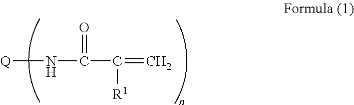
wherein Q represents an n valent linking group; R¹ represents a hydrogen atom or a methyl group; and n represents an integer of 2 or more.

6. The image forming apparatus according to claim 4, wherein the polyfunctional polymerizable compound is a trifunctional, tetrafunctional or pentafunctional (meth)acrylamide compound.

7. The image forming apparatus according to claim 6, wherein the polyfunctional polymerizable compound is a trifunctional or tetrafunctional (meth)acrylamide compound.

8. The image forming apparatus according to claim 3, further comprising a mechanism that controls a temperature of the suction plate.

9. An image forming method comprising:
jetting, onto a recording medium, a curable ink composition including 3% by mass to 18% by mass, based on a total amount of the ink composition, of a polyfunctional polymerizable compound, and water;
gripping a leading end of the recording medium onto which the curable ink composition has been jetted, and conveying the recording medium; and
irradiating light to the recording medium, onto which the curable ink composition has been jetted, during the conveyance of the recording medium.

10. The image forming method according to claim 9, wherein the curable ink composition includes 15% by mass or less, based on the total amount of the ink composition, of the polymerizable compound.

11. The image forming method according to claim 9, wherein the curable ink composition includes 5% by mass or more, based on the total amount of the ink composition, of the polymerizable compound.

12. The image forming method according to claim 9, wherein the polyfunctional polymerizable compound is a polyfunctional (meth)acrylamide compound represented by the following formula (1): 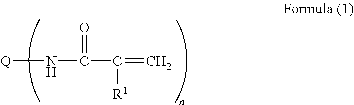
wherein Q represents an n valent linking group; R¹ represents a hydrogen atom or a methyl group; and n represents an integer of 2 or more.

13. The image forming method according to claim 11, wherein the polyfunctional polymerizable compound is a trifunctional, tetrafunctional or pentafunctional (meth)acrylamide compound.

14. The image forming method according to claim 13, wherein the polyfunctional polymerizable compound is a trifunctional or tetrafunctional (meth)acrylamide compound.
